(19) United States
(12) Patent Application Publication
(10) Pub. No.: US 2015/0015934 A1
(43) Pub. Date: Jan. 15, 2015

(54) ELECTROPHORETIC APPARATUS, MANUFACTURING METHOD OF ELECTROPHORETIC APPARATUS, AND ELECTRONIC APPARATUS

(71) Applicant: SEIKO EPSON CORPORATION, Tokyo (JP)

(72) Inventors: Tadashi YAMADA, Matsumoto-shi (JP); Hiroki NAKAHARA, Shiojiri-shi (JP); Yutaka TAKEUCHI, Azumino-shi (JP); Daisuke ABE, Chino-shi (JP); Toru KATAKABE, Fujimi-machi (JP)

(21) Appl. No.: 14/325,719

(22) Filed: Jul. 8, 2014

(30) Foreign Application Priority Data
Jul. 10, 2013 (JP) 2013-144265
Jan. 24, 2014 (JP) 2014-011057

(51) Int. Cl. G02F 1/167; G02F 1/1339

(52) U.S. Cl. CPC G02F 1/167; G02F 1/1339
USPC 359/296; 156/146

(57) ABSTRACT

An electrophoretic apparatus includes: an electrophoretic layer that is disposed between an element substrate and a counter substrate, and has a dispersion medium in which electrophoretic particles are dispersed; a partition wall that is disposed to separate the electrophoretic layer into a plurality of cells; a seal material that bonds the element substrate and the counter substrate, and is disposed so as to surround the electrophoretic layer; and a sealing film that is disposed at least between the partition wall and the counter substrate, and has no adhesive material, in which a top section of the partition wall is disposed in the sealing film.

### BACKGROUND

1. Technical Field

The present invention relates to an electrophoretic apparatus, a manufacturing method of the electrophoretic apparatus, and an electronic apparatus.

2. Related Art

In an electrophoretic apparatus, an image is formed on a display region by spatially moving electrophoretic particles such as black particles or white particles which are charged by applying a voltage between a pixel electrode and a common electrode facing each other across an electrophoretic material. As an electrophoretic apparatus, for example, an apparatus is known having a configuration in which a space between a pair of substrates is divided into a plurality of spaces by partition walls and electrophoretic dispersion liquid including electrophoretic particles and dispersion liquid is sealed inside each space.

For example, an electrophoretic apparatus is described in JP-A-2013-41036, in which a technique is disclosed that enhances a sealing property by a top section of the partition wall being indented into an adhesive layer adhered to the substrate in order to seal the electrophoretic dispersion liquid (electrophoretic ink) without a gap on the inside of a cell.

However, if the top section of the partition wall and the substrate are adhered with adhesive, there is a concern that the electrophoretic particles may adhere to the adhesive and display quality may be deteriorated.

### SUMMARY

The invention can be realized in the following forms or application examples.

### Application Example 1

According to this application example, there is provided an electrophoretic apparatus including: a first substrate; a second substrate that is disposed to face the first substrate; an electrophoretic layer that is disposed between the first substrate and the second substrate, and has a dispersion medium in which electrophoretic particles are dispersed; a partition wall that is disposed to separate the electrophoretic layer into a plurality of cells; a seal material that bonds the first substrate and the second substrate, and is disposed so as to surround the electrophoretic layer; and a sealing film that is disposed at least between the partition wall and the second substrate, and has a low adhesive force, in which a top section of the partition wall is disposed in the sealing film.

In this case, since the top section of the partition wall is disposed in the sealing film that does not include the adhesive material, it is possible to prevent a gap from occurring between the top section and the sealing film (in other words, the second substrate) and to suppress moving of the dispersion medium into the adjacent cell. Furthermore, since the sealing film is formed of the sealing film having the low adhesive force, it is possible to prevent the electrophoretic particles from adhering to the sealing film and to suppress deterioration of display quality.

### Application Example 2

In the electrophoretic apparatus according to the application example, it is preferable that the sealing film do not include an adhesive material.

In this case, since the sealing film does not include the adhesive material, it is possible to prevent impurities from dispersing in the dispersion medium from the sealing film and the impurities from adhering to the electrophoretic particles. Therefore, it is possible to suppress deterioration of display quality without affecting the electrophoresis property of the electrophoretic particles.

### Application Example 3

In the electrophoretic apparatus according to the application example, it is preferable that a size of one side of a display region of the electrophoretic layer be 55 mm or less.

In this case, since the electrophoretic apparatus having the display region of 55 mm or less is a target, even if manufacturing variations occur in the height of the top section of the partition wall or the substrate is bent, it is possible for the top section to be indented into the sealing film and to prevent a gap from occurring between the sealing film and the partition wall.

### Application Example 4

In the electrophoretic apparatus according to the application example, it is preferable that an end section of the sealing film overlap with a dummy pixel region in a plan view.

In this case, since the end section of the sealing film overlaps with the dummy pixel region in the plan view, even if variation occurs in the size of the sealing film, it is possible to dispose the end section in the dummy pixel region and to suppress affecting the display quality.

### Application Example 5

In the electrophoretic apparatus according to the application example, the sealing film may include a first sealing film that is disposed between the partition wall and the second substrate, and a second sealing film that is disposed between the first sealing film and the partition wall, and a portion of a contact surface between the first sealing film and the second sealing film, which overlaps with the partition wall in a plan view is positioned nearer to the side of the second substrate in a cross-sectional view, than a portion which does not overlap with the partition wall in a plan view.

In this case, since the top section of the partition wall is indented into the first sealing film and the second sealing film, it is possible to prevent a gap from occurring between the top section and the sealing film (the first sealing film and the second sealing film) and to suppress moving of the dispersion medium into the adjacent cell. Furthermore, since, for example, the first sealing film (a material having a high adhesive property) is disposed on the side that does not come into contact with the dispersion medium, and the second sealing film is disposed on the side that comes into contact with the dispersion medium by forming the sealing film with two layers (the first sealing film and the second sealing film), it is possible to prevent the electrophoretic particles from adhering to the sealing film and to suppress deterioration of display quality.

### Application Example 6

In the electrophoretic apparatus according to the application example, it is preferable that an elastic modulus of the first sealing film be 5 MPa or more and 40 MPa or less, and an elastic modulus of the second sealing film be 50 MPa or more and 600 MPa or less.

In this case, it is possible to prevent the electrophoretic particles from adhering to the second sealing film by setting the elastic moduli of the first sealing film and the second sealing film as described above. Therefore, it is possible to suppress the deterioration of display quality.

### Application Example 7

In the electrophoretic apparatus according to the application example, it is preferable that a film thickness of the first sealing film be 2.5 μm or more and 7.5 μm or less, and a film thickness of the second sealing film be 0.05 μm or more and 0.5 μm or less.

In this case, since the top section of the partition wall is indented into the first sealing film and the second sealing film by setting the film thicknesses of the first sealing film and the second sealing film as described above, it is possible to prevent a gap from occurring between the top section and the sealing film (the first sealing film and the second sealing film) and to suppress moving of the dispersion medium into the adjacent cell.

### Application Example 8

In the electrophoretic apparatus according to the application example, it is preferable that an amount of an additive to be added to the first sealing film be 5 wt % or more and 50 wt % or less in a solid content of the first sealing film.

In this case, since the first sealing film is softened by adding the additive as described above, it is possible for the top section of the partition wall to be indented into the first sealing film and the second sealing film, and to prevent a gap from occurring between the top section and the sealing film (the first sealing film and the second sealing film). As a result, it is possible to suppress moving of the dispersion medium into the adjacent cell.

### Application Example 9

In the electrophoretic apparatus according to the application example, it is preferable that a volume resistivity of the first sealing film be 1×10⁷ Ω·cm or more and 5×10¹⁰ Ω·cm or less, and a volume resistivity of the second sealing film be 1×10⁷ Ω·cm or more and 2×10¹¹ Ω·cm or less.

In this case, it is possible for the electrophoresis property of the electrophoretic particles to be in an appropriate range by using the material having the electric resistance as described above.

### Application Example 10

According to this application example, there is provided a manufacturing method of an electrophoretic apparatus including: forming a partition wall on a first substrate to separate a dispersion medium including electrophoretic particles into a plurality of cells; applying a seal material around a display region of the first substrate; forming a sealing film having a low adhesive force on a second substrate that is disposed to face the first substrate; supplying the dispersion medium in the display region of the first substrate; and bonding the first substrate and the second substrate through the seal material and causing a top section of the partition wall to be indented into the sealing film.

In this case, since the top section of the partition wall is indented into the sealing film that does not include the adhesive material, it is possible to prevent a gap from occurring between the top section and the sealing film (in other words, the second substrate) and to suppress moving of the dispersion medium into the adjacent cell. Furthermore, since the sealing film is formed of the sealing film having the low adhesive force, it is possible to prevent the electrophoretic particles from adhering to the sealing film and to suppress deterioration of display quality.

### Application Example 11

In the manufacturing method of an electrophoretic apparatus according to the application example, it is preferable that the sealing film be formed of a material that does not include an adhesive material.

In this case, since the sealing film does not include the adhesive material, it is possible to prevent the impurities from dispersing in the dispersion medium from the sealing film and the impurities from adhering to the electrophoretic particles. Therefore, it is possible to suppress deterioration of display quality without affecting the electrophoresis property of the electrophoretic particles.

### Application Example 12

In the manufacturing method of an electrophoretic apparatus according to the application example, it is preferable that the bonding of the first substrate and the second substrate be performed under a pressure lower than atmospheric pressure while heating the sealing film.

In this case, since the bonding is performed under the pressure lower than the atmospheric pressure while heating the sealing film, it is possible for the top section to be indented into the sealing film and to manufacture a panel having no air bubbles.

### Application Example 13

In the manufacturing method of an electrophoretic apparatus according to the application example, the forming of the sealing film may include forming a first sealing film on the second substrate that is disposed to face the first substrate, and forming a second sealing film so as to cover the first sealing film, and in causing the top section of the partition wall to be indented into the sealing film, the top section of the partition wall may be indented into the first sealing film and the second sealing film.

In this case, since the top section of the partition wall is indented into the first sealing film and the second sealing film, it is possible to prevent a gap from occurring between the top section and the sealing film (the first sealing film and the second sealing film) and to suppress moving of the dispersion medium into the adjacent cell. Furthermore, since, for example, the first sealing film is disposed on the side that does not come into contact with the dispersion medium, and the second sealing film is disposed on the side that comes into contact with the dispersion medium by forming the sealing film with two layers (the first sealing film and the second sealing film), it is possible to prevent the electrophoretic particles from adhering to the sealing film and to suppress deterioration of display quality even if the first sealing film is formed of the material having the adhesive property.

### Application Example 14

In the manufacturing method of an electrophoretic apparatus according to the application example, it is preferable that in the second sealing film, a film thickness be thin and film hardness be hard as compared to those in the first sealing film.

In this case, since the second sealing film has thin film thickness and is hard, it is possible for the partition wall to be indented into the second sealing film and to prevent the electrophoretic particles from adhering to the second sealing film. Therefore, it is possible to suppress the deterioration of display quality.

### Application Example 15

In the manufacturing method of an electrophoretic apparatus according to the application example, it is preferable that an elastic modulus of the first sealing film be 5 MPa or more and 40 MPa or less, and an elastic modulus of the second sealing film be 50 MPa or more and 600 MPa or less.

In this case, it is possible to prevent the electrophoretic particles from adhering to the second sealing film by setting the elastic moduli of the first sealing film and the second sealing film as described above. Therefore, it is possible to suppress the deterioration of display quality.

### Application Example 16

In the manufacturing method of an electrophoretic apparatus according to the application example, it is preferable that a film thickness of the first sealing film be 2.5 μm or more and 7.5 μm or less, and a film thickness of the second sealing film be 0.05 μm or more and 0.5 μm or less.

In this case, since the thickness of the first sealing film that is soft is thick and the film thickness of the second sealing film that is hard is thin, it is possible for the top section of the partition wall to be indented into the first sealing film and the second sealing film, and to prevent a gap from occurring between the top section and the sealing film (the first sealing film and the second sealing film). As a result, it is possible to suppress moving of the dispersion medium into the adjacent cell and to suppress adhering of the electrophoretic particles to the sealing film.

### Application Example 17

In the manufacturing method of an electrophoretic apparatus according to the application example, it is preferable that an additive lowering the elastic modulus be added to a material of the second sealing film.

In this case, since the second sealing film is softened by adding the additive, it is possible for the top section of the partition wall to be indented into the first sealing film and the second sealing film, and to prevent a gap from occurring between the top section and the sealing film (the first sealing film and the second sealing film). As a result, it is possible to suppress moving of the dispersion medium into the adjacent cell.

### Application Example 18

In the manufacturing method of an electrophoretic apparatus according to the application example, it is preferable that an amount of additive to be added to the first sealing film be 5 wt % or more and 50 wt % or less in a solid content of the first sealing film.

In this case, since the first sealing film is softened by adding the additive as described above, it is possible for the top section of the partition wall to be indented into the first sealing film and the second sealing film, and to prevent a gap from occurring between the top section and the sealing film (the first sealing film and the second sealing film). As a result, it is possible to suppress moving of the dispersion medium into the adjacent cell.

### Application Example 19

In the manufacturing method of an electrophoretic apparatus according to the application example, it is preferable that a volume resistivity of the first sealing film be 1×10⁷ Ω·cm or more and 5×10¹⁰ Ω·cm or less, and a volume resistivity of the second sealing film be 1×10⁷ Ω·cm or more and 2×10¹¹ Ω·cm or less.

In this case, it is possible to apply a suitable driving voltage between a pair of electrodes by using the material having the electric resistance as described above.

### Application Example 20

According to this application example, there is provided an electronic apparatus including the electrophoretic apparatus described above.

In this case, since the electrophoretic apparatus described above is included, it is possible to provide the electronic apparatus in which deterioration of display quality is suppressed.

### BRIEF DESCRIPTION OF THE DRAWINGS

The invention will be described with reference to the accompanying drawings, wherein like numbers reference like elements.

FIG. 1 is a perspective view of an electronic apparatus on which an electrophoretic apparatus of a first embodiment is mounted.

FIG. 2 is an equivalent circuit diagram illustrating an electrical configuration of the electrophoretic apparatus.

FIG. 3 is a schematic plan view illustrating a structure of the electrophoretic apparatus.

FIG. 4 is a schematic cross-sectional view of the electrophoretic apparatus taken along line IV-IV illustrated in FIG. 3.

FIG. 5 is a schematic plan view illustrating a structure of a sealing film and a periphery of a seal section in the electrophoretic apparatus.

FIG. 6 is a schematic cross-sectional view of the electrophoretic apparatus taken along line VI-VI illustrated in FIG. 5.

FIG. 7 is an enlarged plan view illustrating a VII portion of the electrophoretic apparatus illustrated in FIG. 5 by enlargement.

FIG. 8 is an enlarged cross-sectional view illustrating a VIII portion of the electrophoretic apparatus illustrated in FIG. 6 by enlargement.

FIG. 9 is a flowchart illustrating a manufacturing method of the electrophoretic apparatus in order of steps.

FIGS. 10A to 10D are schematic cross-sectional views illustrating a part of the manufacturing method in the manufacturing method of the electrophoretic apparatus.

FIGS. 11E to 11H are schematic cross-sectional views illustrating a part of the manufacturing method in the manufacturing method of the electrophoretic apparatus.

FIG. 12 is a graph illustrating temperature dependency of an indentation amount in the sealing film.

FIG. 13 is a graph illustrating a displacement amount near a center of the electrophoretic apparatus (panel).

FIG. 14 is a schematic plan view illustrating a structure of an electrophoretic apparatus of a second embodiment.

FIG. 15 is a schematic cross-sectional view of the electrophoretic apparatus taken along line XV-XV illustrated in FIG. 14.

FIG. 16 is a schematic plan view illustrating a structure of a sealing film and a periphery of a seal section in the electrophoretic apparatus.

FIG. 17 is a schematic cross-sectional view of the electrophoretic apparatus taken along line XVII-XVII illustrated in FIG. 16.

FIG. 18 is an enlarged plan view illustrating an XVIII portion of the electrophoretic apparatus illustrated in FIG. 16 by enlargement.

FIG. 19 is an enlarged cross-sectional view illustrating an XIX portion of the electrophoretic apparatus illustrated in FIG. 17 by enlargement.

FIG. 20 is a flowchart illustrating a manufacturing method of the electrophoretic apparatus in order of steps.

FIGS. 21A to 21D are schematic cross-sectional views illustrating a part of the manufacturing method in the manufacturing method of the electrophoretic apparatus.

FIGS. 22E to 22H are schematic cross-sectional views illustrating a part of the manufacturing method in the manufacturing method of the electrophoretic apparatus.

### DESCRIPTION OF EXEMPLARY EMBODIMENTS

Hereinafter, an embodiment that embodies the invention will be described with reference to the drawings. Moreover, it should be noted that the drawings to be used are appropriately enlarged or reduced so that portions which are described are in recognizable states.

Moreover, in the following aspect, for example, if described as “on a substrate”, this is intended to refer to a case of being disposed so as to contact the substrate, a case of being disposed on the substrate through other configuration matter, or a case where a part is disposed on the substrate and another part is disposed through other configuration matter.

### First Embodiment

### Configuration of Electronic Apparatus

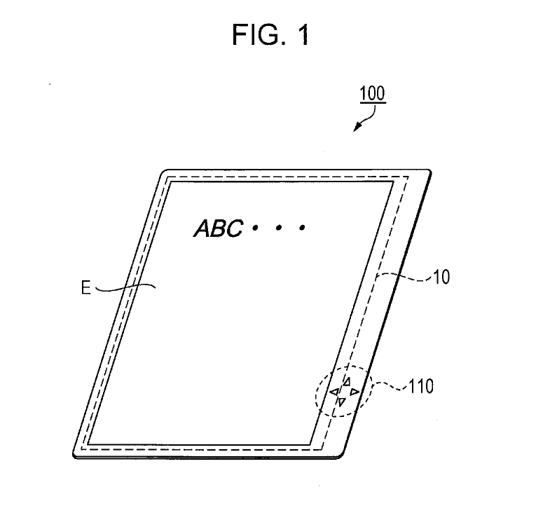

FIG. 1 is a perspective view of an electronic apparatus on which an electrophoretic apparatus is mounted. Hereinafter, a configuration of the electronic apparatus will be described with reference to FIG. 1.

As illustrated in FIG. 1, an electronic apparatus 100 includes an electrophoretic apparatus 10 and an interface for operating the electronic apparatus 100. Specifically, the interface is configured of a switch and the like in an operation section 110.

The electrophoretic apparatus 10 is a display module having a display region E. The display region E is formed of a plurality of pixels and an image is displayed on the display region E by electrically controlling the pixels.

Moreover, the electronic apparatus 100 including the electrophoretic apparatus 10 may be applied to an Electronic Paper Display (EPD), a watch, a wrist-wearable apparatus, and the like.

### Electrical Configuration of Electrophoretic Apparatus

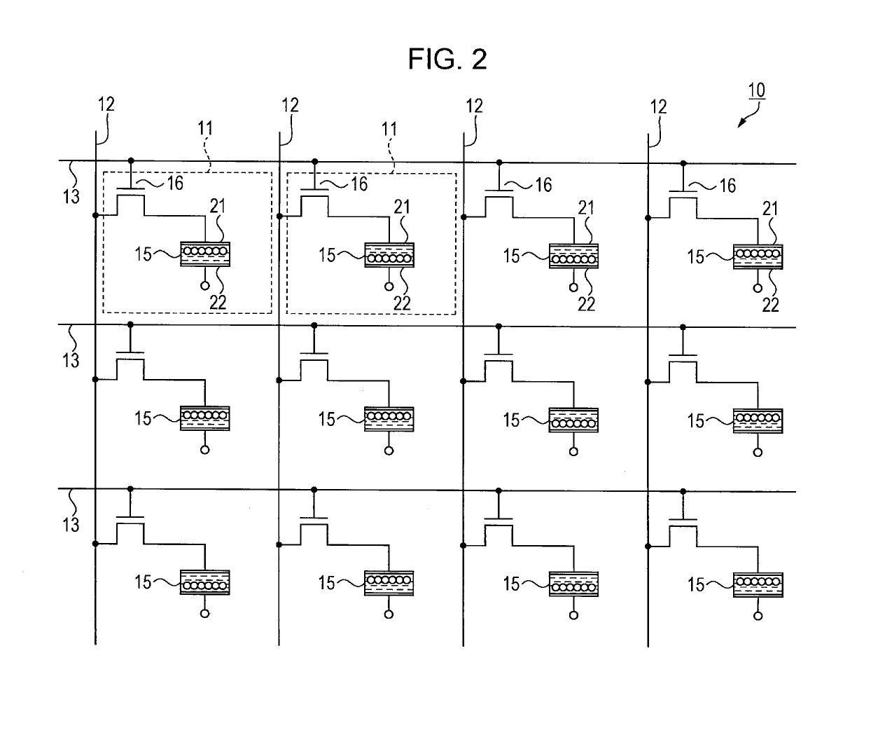

FIG. 2 is an equivalent circuit diagram illustrating an electrical configuration of the electrophoretic apparatus. The electrical configuration of the electrophoretic apparatus will be described with reference to FIG. 2.

As illustrated in FIG. 2, the electrophoretic apparatus 10 has a plurality of data lines 12 and a plurality of scanning lines 13, and pixels 11 are disposed in portions where the data lines 12 and the scanning lines 13 intersect with each other. Specifically, the electrophoretic apparatus 10 has a plurality of pixels 11 disposed in a matrix shape along the data lines 12 and the scanning lines 13. Each pixel 11 has a dispersion medium 15 including electrophoretic particles disposed between a pixel electrode 21 and a common electrode 22.

The pixel electrode 21 is connected to the data line 12 through a transistor 16 (a TFT 16). A gate electrode of the TFT 16 is connected to the scanning line 13. Moreover, FIG. 2 is an example and other elements such as a holding capacitor may be incorporated, if necessary.

### Structure of Electrophoretic Apparatus

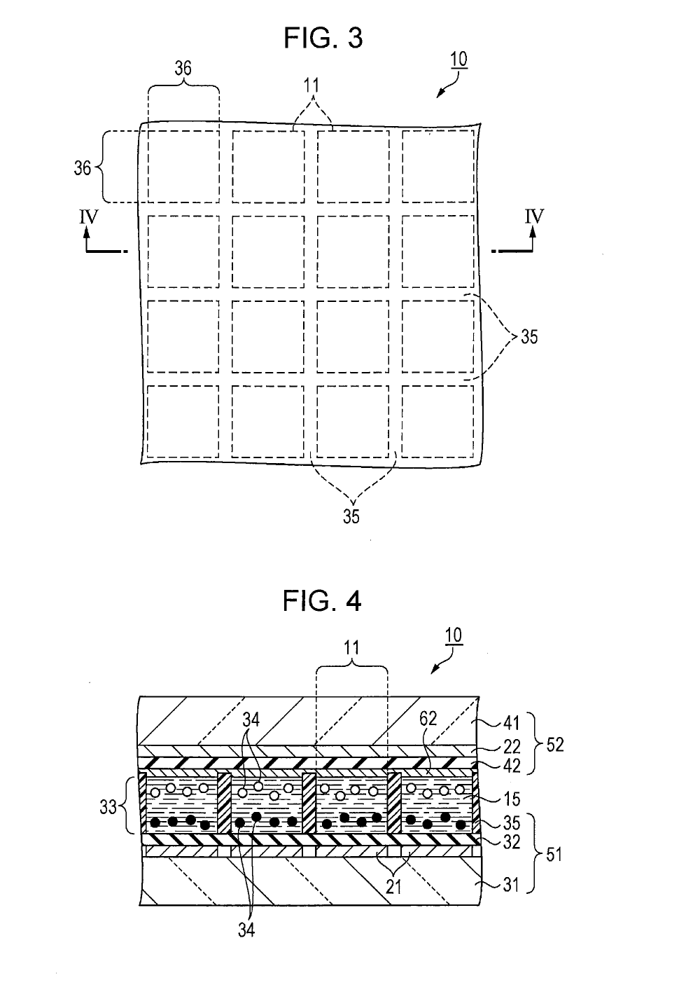

FIG. 3 is a schematic plan view illustrating a structure of the electrophoretic apparatus. FIG. 4 is a schematic cross-sectional view of the electrophoretic apparatus taken along line IV-IV illustrated in FIG. 3. Hereinafter, the structure of the electrophoretic apparatus will be described with reference to FIGS. 3 and 4.

As illustrated in FIGS. 3 and 4, the electrophoretic apparatus 10 has an element substrate 51 as a first substrate, a counter substrate 52 as a second substrate, and an electrophoretic layer 33. A pixel electrode 21 is disposed on a first base material 31 that configures the element substrate 51 and, for example, is formed of a glass substrate having translucency for each pixel 11.

More specifically, as illustrated in FIGS. 3 and 4, the pixel 11 (the pixel electrode 21) is, for example, formed in a matrix shape in a plan view. For example, as a material of the pixel electrode 21, a light transmitting material such as Indium Tin Oxide (ITO; indium oxide to which tin is added) is used.

A circuit section (not illustrated) is provided between the first base material 31 and the pixel electrode 21, and the TFT 16 and the like are formed in the circuit section. The TFT 16 is electrically connected to each pixel electrode 21 through a contact section (not illustrated). Moreover, even though not illustrated, various wirings (for example, the data line 12, the scanning line 13, or the like), an element (a capacitance element), or the like is disposed in the circuit section in addition to the TFT 16. A first insulation layer 32 is formed on an entire surface on the first base material 31 including the pixel electrode 21. Moreover, the first insulation layer 32 may not be provided.

The common electrode 22 provided commonly to the plurality of pixels 11 is formed on a second base material 41 configuring the counter substrate 52, which is, for example, made from a glass substrate having translucency. For example, as the common electrode 22, a light transmitting material such as ITO is used. A second insulation layer 42 is formed on an entire surface on the common electrode 22. Moreover, the second insulation layer 42 may not be provided.

The electrophoretic layer 33 is provided between the first insulation layer 32 and the second insulation layer 42. The dispersion medium 15 in which at least one or more electrophoretic particles 34 configuring the electrophoretic layer 33 are dispersed is filled into a space partitioned by the first insulation layer 32, the second insulation layer 42, and partition walls 35 (ribs) provided on the first base material 31. As illustrated in FIG. 3, the partition walls 35 are formed in a grid shape. Moreover, the partition wall 35 is preferably formed in a translucent material (acryl, epoxy resin, or the like). For example, a thickness of the partition wall 35 is 5 μm. In the example, the pixel electrode 21 is disposed for each pixel 11 and the partition wall 35 (rib) is disposed for each pixel electrode 21, but the invention is not limited to the example and the partition wall (rib) may be formed for a plurality of pixels, for example, for 2 to 20 pixels.

Furthermore, when bonding the element substrate 51 and the counter substrate 52, it is possible to determine a cell gap between the element substrate 51 and the counter substrate 52 relative to a height of the partition wall 35 by contacting an upper section of the partition wall 35 with the counter substrate 52 (specifically, a sealing film 62).

White particles and black particles are illustrated in FIG. 4, as the electrophoretic particles 34. For example, when a voltage is applied between the pixel electrode 21 and the common electrode 22, according to an electric field generated therebetween, the electrophoresis of the electrophoretic particles 34 is performed toward either electrode (the pixel electrode 21 and the common electrode 22). For example, if the white particles have a positive charge and the pixel electrode 21 has a negative potential, the white particles are moved to and collected on the side (lower side) of the pixel electrode 21, and a black display is brought about.

On the contrary, if the pixel electrode 21 has a positive potential, the white particles are moved to and collected on the side (upper side) of the common electrode 22, and a white display is brought about. As described above, desired information (image) is displayed depending on presence or absence, the number, or the like of the white particles collected at the electrodes on the sides of the display. Moreover, here, the white particles or the black particles are used as the electrophoretic particles 34, but other color particles may be used.

Furthermore, as the electrophoretic particles 34, it is possible to use particles of inorganic pigment, particles of organic pigment, polymeric microparticles, or the like, and to use particles into which various particles of two types or more are mixed. For example, the electrophoretic particles 34 is used in which a diameter of the electrophoretic particles 34 is approximately 0.05 μm to 10 μm and preferably is approximately 0.2 μm to 2 μm.

Furthermore, a content of the white particles is 30% or less relative to a total weight of the dispersion medium 15, the white particles, and the black particles and a content of the black particles is 10% or less relative to the total weight of the dispersion medium 15, the white particles, and the black particles. Reflectance is 40% or more and the black reflectance is 2% or less, and it is possible to increase display performance by distributing as described above.

In the embodiment, as the dispersion medium 15, silicone oil in which the electrophoretic particles 34 are movable even at a temperature of approximately −30° C. is used. However, since in the silicone oil, a surface energy is low and a cohesive strength is low because a surface of a molecule is covered with methyl groups, an adhesive strength by seal materials 14a and 14b may be remarkably lowered by attaching the silicone oil to seal the materials 14a and 14b. For example, viscosity of the silicone oil is 10 cP or less. Since the silicone oil is a low-viscosity solvent, for example, the electrophoresis of the electrophoretic particles can be performed between the electrodes at a speed of 500 ms or less even at a low temperature of approximately −30° C.

Moreover, hereinafter, a region surrounded by the partition walls 35 is referred to as a cell 36. One cell 36 includes the pixel electrode 21, the common electrode 22, and the electrophoretic layer 33.

### Structure of Sealing Film and Periphery of Seal Section

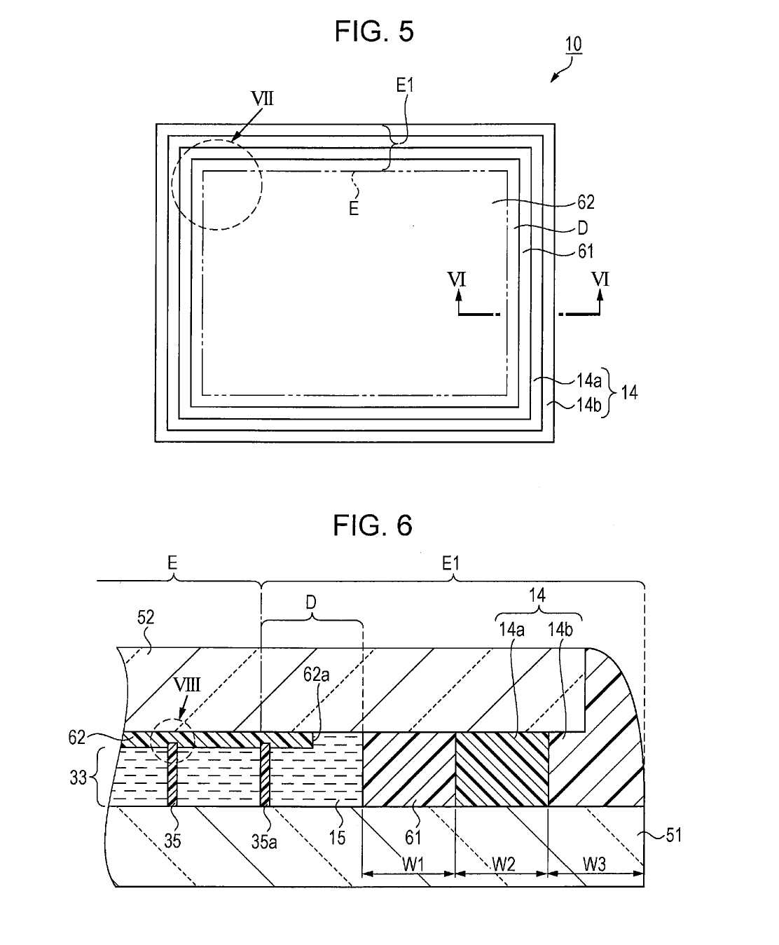

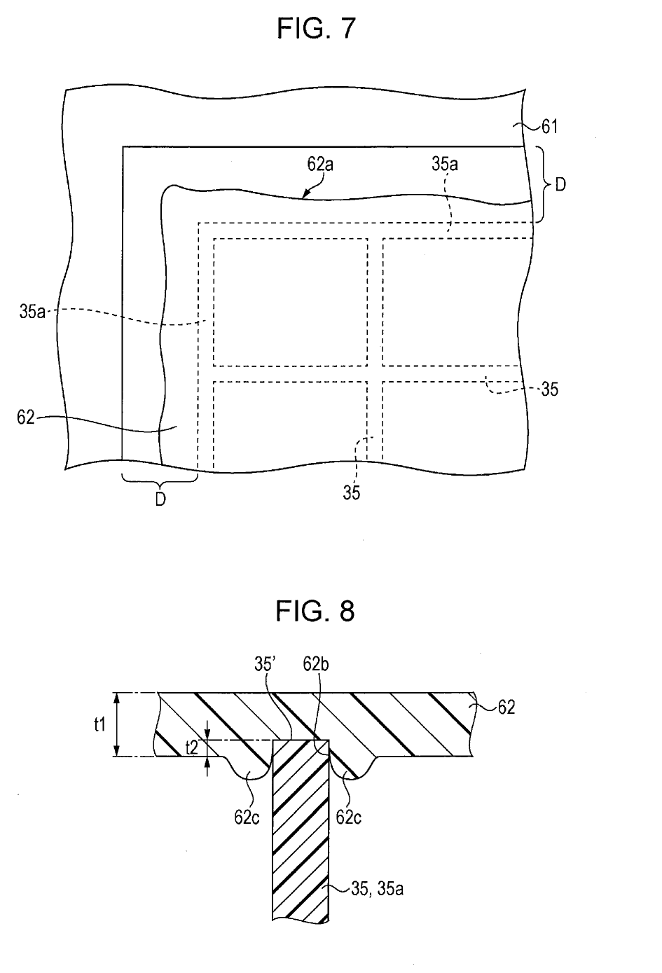

FIG. 5 is a schematic plan view illustrating a structure of a sealing film and a periphery of a seal section in the electrophoretic apparatus. FIG. 6 is a schematic cross-sectional view of the electrophoretic apparatus taken along line VI-VI illustrated in FIG. 5. FIG. 7 is an enlarged plan view illustrating a VII portion of the electrophoretic apparatus illustrated in FIG. 5 by enlargement. FIG. 8 is an enlarged cross-sectional view illustrating a VIII portion of the electrophoretic apparatus illustrated in FIG. 6 by enlargement. Hereinafter, the structure of the sealing film and the periphery of the seal section of the electrophoretic apparatus will be described with reference to FIGS. 5 to 8. Moreover, illustration of the insulation layer, the wirings, the electrodes, and the like are omitted.

As illustrated in FIGS. 5 and 6, the electrophoretic apparatus 10 has a frame edge region E1 so as to surround the display region E. The frame edge region E1 includes a dummy pixel region D that is a region doing not contribute to the display of the electrophoretic layer 33, a frame edge partition wall 61 that is disposed on the outside of the dummy pixel region D, and a seal section 14 that is disposed on the outside of the frame edge partition wall 61. A width of the frame edge region E1 is, for example, approximately 1 mm.

A width of the dummy pixel region D is, for example, 30 μm. A partition wall 35a that is formed in the same shape as the partition wall 35 disposed in the display region E is provided on the side of the display region E of the dummy pixel region D. In the embodiment, a rib width (width of a top section 35′) of the partition wall is 5 μm. A distance between adjacent partition walls is, for example, 150 μm.

The frame edge partition wall 61 is provided on the outside of the dummy pixel region D. The frame edge partition wall 61 can intercept the dispersion medium 15 so that it does not flow out to the outside and is used to adjust the cell gap, and is disposed so as to surround the dummy pixel region D. Moreover, the frame edge partition wall 61 is configured of the same material as that of the partition wall 35 of the display region E.

A width W1 of the frame edge partition wall 61 is, for example, 150 μm. A thickness of the frame edge partition wall 61 is, for example, in a range of 10 μm to 50 μm. The thickness thereof is 30 μm in the embodiment. Moreover, the frame edge partition wall 61 is also used for a first seal material 14a disposed adjacent to the frame edge partition wall 61 to not protrude in the display region E.

The seal section 14 has the first seal material 14a and a second seal material 14b. The first seal material 14a is provided for adhering when bonding the element substrate 51 and the counter substrate 52, and is provided to surround the frame edge partition wall 61. A width W2 of the first seal material 14a is, for example, 400 μm. The viscosity of the first seal material 14a is, for example, 300000 Pa·s to 1000000 Pa·s. Preferably, the viscosity thereof is approximately 400000 Pa·s. It is possible to maintain a contact area between the element substrate 51 and the counter substrate 52 by using the first seal material 14a having such a viscosity when bonding.

The second seal material 14b is used for sealing between the element substrate 51 and the counter substrate 52, and is disposed so as to surround the first seal material 14a. A width w3 of the second seal material 14b is, for example, 400 μm. A viscosity of the second seal material 14b is, for example, 100 Pa·s to 500 Pa·s. Preferably, the viscosity thereof is approximately 400 Pa·s. It is possible for the second seal material 14b to enter between the element substrate 51 and the counter substrate 52 at the periphery of the first seal material 14a and to improve the adhesive strength of the second seal material 14b by using the second seal material 14b having such a viscosity.

Furthermore, it is possible to suppress entering of moisture to the inside from the outside through the second seal material 14b and the first seal material 14a and to obtain a highly reliable seal structure.

As illustrated in FIGS. 6 and 8, the sealing film 62 is provided between the top section 35′ of the partition wall 35 at least in the display region E and the counter substrate 52 so that the dispersion medium 15 or the electrophoretic particles 34 are prevented from coming and going between the adjacent cells 36. Specifically, a material of the sealing film 62 may be a material which is a thermoplastic and has high translucency and of which electrical resistance is 1×10¹² or less, and is, for example, configured of a transparent resin such as polyvinyl alcohol (PVA). Furthermore, the sealing film 62 has no adhesive (adhesive material). As illustrated in FIG. 8, the top section 35′ of the partition wall 35 is indented into the sealing film 62.

If an adhesive is used as the material forming the sealing film 62, the adhesive (for example, impurities such as reactive monomer that is not fully cured) contained in the adhesive layer is dispersed in the dispersion medium so that there is a concern that the adhesive is adhered to the electrophoretic particles included in dispersion liquid and may affect an electrophoresis property of the electrophoretic particles 34. In the embodiment, since the sealing film 62 is formed by using a material having almost no such additives, it is possible to reduce such a problem.

For example, as a material other than PVA, polyethylene oxide, acrylonitrile styrene, and the like may be used. Furthermore, it is possible to use synthetic rubber such as acrylonitrile butadiene rubber.

As illustrated in FIG. 8, a thickness t1 of the sealing film 62 is satisfactory as long as the electric field is not disturbed, and is, for example, 3 μm to 5 μm. An indentation amount t2 of the partition wall 35 into the sealing film 62 is, for example, 1 μm to 2 μm. Furthermore, strength of an interface of the sealing film 62 is weak. For example, the top section 35′ of the partition wall 35 and the sealing film 62, or the sealing film 62 and the counter substrate 52 have an adhesive force to an extent of peeling them off with a force of approximately 0.1 N to 1 N. Thus, since the counter substrate 52 is peeled off if the sealing film 62 is disposed between the counter substrate 52 and the seal section 14 (the first seal material 14a and the second seal material 14b), the sealing film 62 and the seal section 14 are disposed so as not to overlap in a plan view.

Furthermore, as illustrated in FIG. 8, a portion of the sealing film 62 into which the top section 35′ of the partition wall 35 is indented is a concave-convex shape and the top section 35′ of the partition wall 35 is fitted into a concave section 62b of the sealing film 62. A convex section 62c is formed in a periphery of the concave section 62b into which the top section 35′ is fitted in the sealing film 62 so as to surround the partition wall 35. It is possible to increase a depth of the fitting and to suppress a gap that is formed between the sealing film 62 (in other words, the counter substrate 52) and the partition wall 35 by fitting the top section 35′ of the partition wall 35 into a groove formed of the convex section 62c and the concave section 62b even if the thickness of the sealing film 62 is as thin as 5 μm. As a result, it is possible to suppress the dispersion medium 15 flowing into the adjacent cell 36.

As illustrated in FIGS. 6 and 7, for example, an end section 62a of the sealing film 62 is disposed between the partition wall 35a of the outermost periphery of the display region E and the frame edge partition wall 61, that is, in a range of the dummy pixel region D. The sealing film 62 is sized slightly larger than the display region E and is sized such that the end section 62a does not enter the display region E even if variation occurs in the size. Hereinafter, a manufacturing method of the electrophoretic apparatus 10 will be described.

### Manufacturing Method of Electrophoretic Apparatus

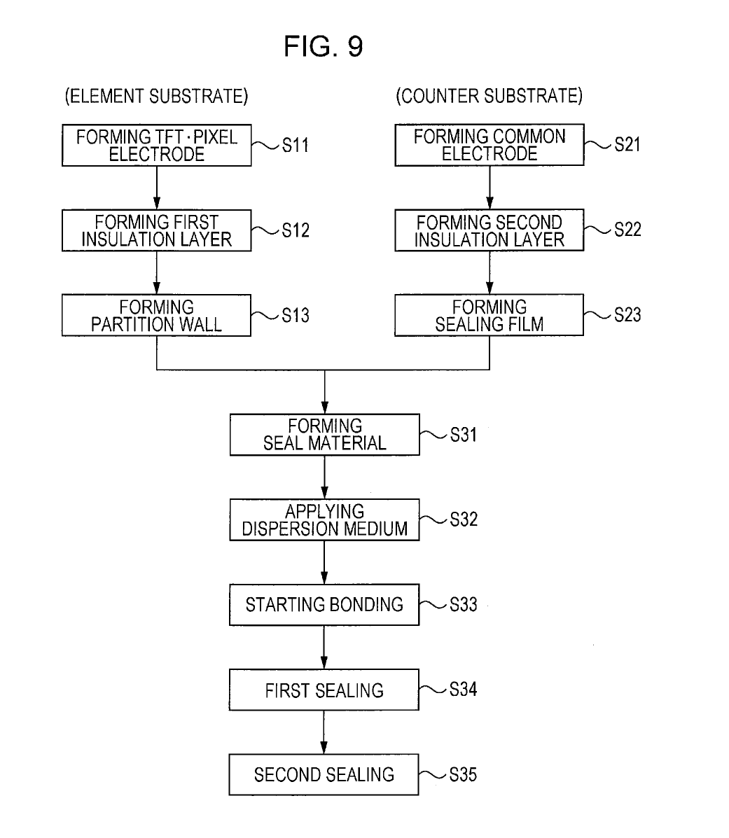

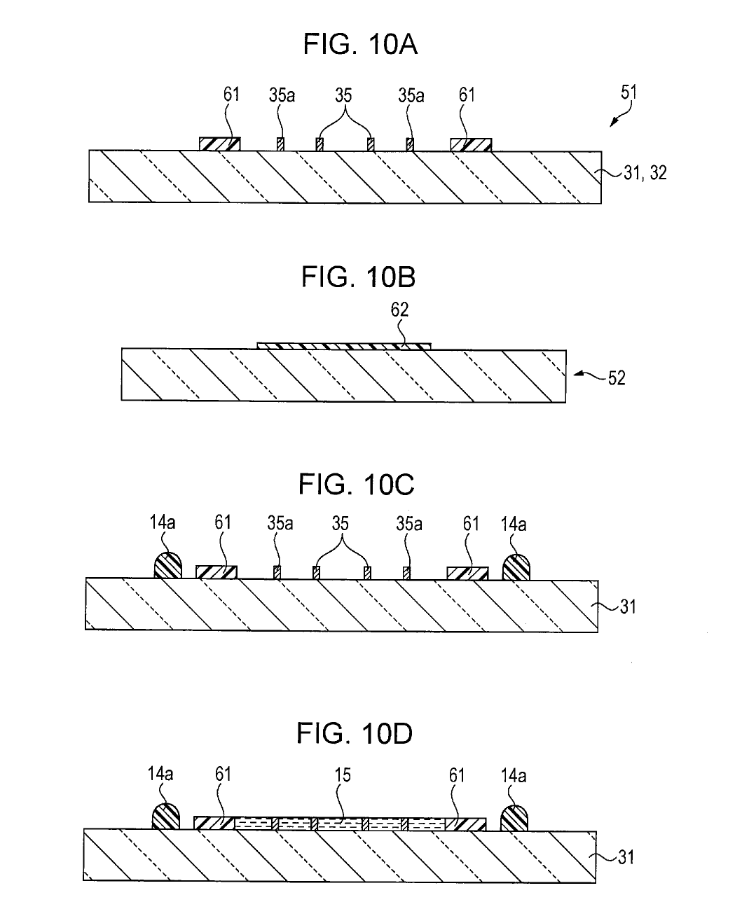

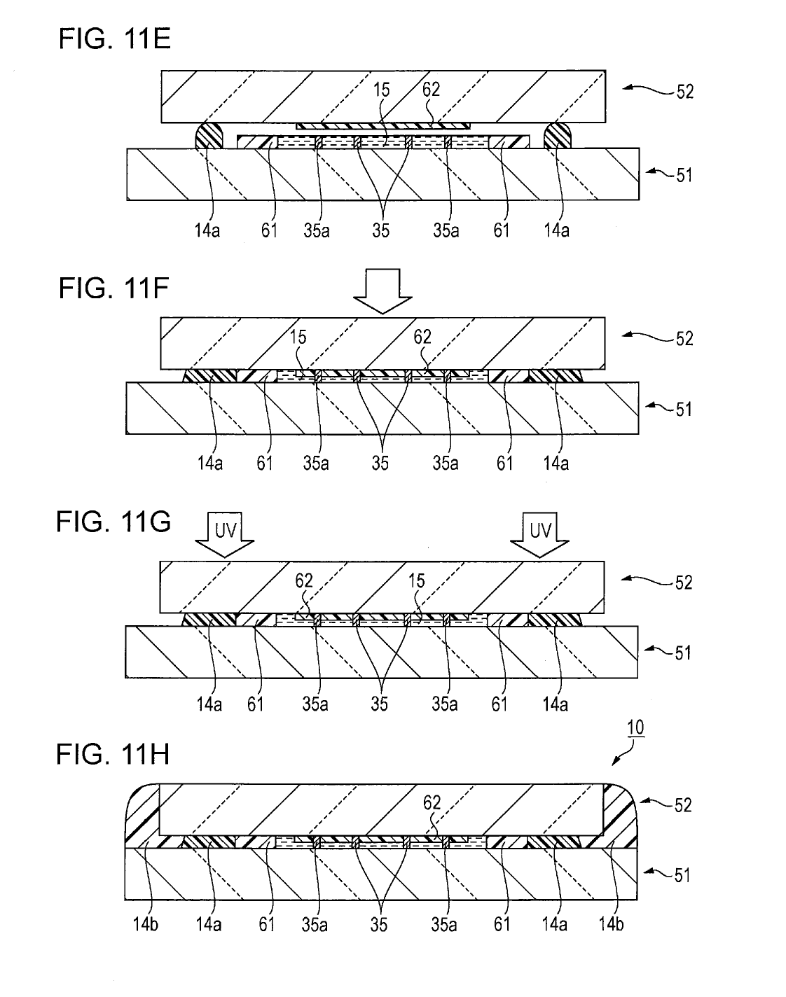

FIG. 9 is a flowchart illustrating a manufacturing method of the electrophoretic apparatus in order of steps. FIGS. 10A to 10D and 11E to 11H are schematic cross-sectional views illustrating a part of the manufacturing method in the manufacturing method of the electrophoretic apparatus. Hereinafter, the manufacturing method of the electrophoretic apparatus will be described with reference to FIGS. 9, 10A to 10D, and 11E to 11H.

First, the manufacturing method of the element substrate 51 is described with reference to FIG. 9. In step S11, the TFT 16, the pixel electrode 21 formed of a light transmitting material such as ITO, or the like is formed on the first base material 31 formed of a translucent material such as glass. Specifically, the TFT 16, the pixel electrode 21, and the like are formed on the first base material 31 by using known film deposition techniques, photolithography techniques and etching techniques. Moreover, in the following description using the cross-sectional views, description and illustration of the TFT 16, the pixel electrode 21, or the like are omitted.

In step S12, the first insulation layer 32 is formed on the first base material 31. As a manufacturing method of the first insulation layer 32, for example, an insulation material is applied on the first base material 31 using a spin coat method and the like, and then it is possible to form the first insulation layer 32 by drying the insulation material.

In step S13, as illustrated in FIG. 10A, the partition wall 35 is formed on the first base material 31 (specifically, the first insulation layer 32). Specifically, the partition wall 35 of the display region E, the partition wall 35a of the outermost periphery of the display region E, and the frame edge partition wall 61 provided on the outside thereof are simultaneously formed. For example, the partition walls 35 and 35a, and the frame edge partition wall 61 can be formed by using known film deposition techniques, photolithography techniques and etching techniques.

As described above, it is possible to efficiently manufacture the partition walls 35 and 35a, and the frame edge partition wall 61 by simultaneously forming with the same material. As described above, the element substrate 51 is completed.

The partition wall 35 is formed of a material that is insoluble in the dispersion medium 15, and it does not matter whether the material is inorganic or organic matter. Specifically, as examples of organic materials, urethane resin, urea resin, acrylic resin, polyester resin, silicone resin, acryl silicone resin, epoxy resin, polystyrene resin, styrene acrylic resin, polyolefin resin, butyral resin, vinylidene chloride resin, melamine resin, phenol resin, fluorine resin, polycarbonate resin, polysulfone resin, polyether resin, polyamide resin, polyimide resin or the like may be exemplified. A single body or combined body of two types or more resins are used.

Subsequently, a manufacturing method of the counter substrate 52 will be described. In step S21, the common electrode 22 is formed on the second base material 41. Specifically, the common electrode 22 is formed on an entire surface on the second base material 41 formed of a translucent material such as a glass substrate by using known film deposition techniques.

In step S22, the second insulation layer 42 is formed on the common electrode 22. As a forming method of the second insulation layer 42, for example, it is possible to form the second insulation layer 42 with the same method as that of the first insulation layer 32 described above.

In step S23, as illustrated in FIG. 10B, the sealing film 62 is formed on the second insulation layer 42. As described above, a material of the sealing film 62 is polyvinyl alcohol (PVA) and the like having no adhesive property. A forming method of the sealing film 62 is performed by using an applying method, a printing method, or the like. As described above, the counter substrate 52 is completed.

Subsequently, a bonding method between the element substrate 51 and the counter substrate 52 will be described with reference to FIGS. 9, 10A to 10D, and 11E to 11H.

First, in step S31, as illustrated in FIG. 10C, the first seal material 14a is applied on an outer periphery of the frame edge partition wall 61 in the atmosphere. For example, a material of the first seal material 14a is Kayatoron that is one-part liquid epoxy resin having relatively high viscosity. The viscosity of the first seal material 14a is, for example, 300000 Pa·s to 1000000 Pa·s. Preferably, the viscosity thereof is 400000 Pa·s. A width of the first seal material 14a when applied is a width sufficient to withstand a vacuum and, for example, is 150 μm.

In step S32, as illustrated in FIG. 10D, the dispersion medium 15 formed of silicone oil including the electrophoretic particles 34 (the white particles and the black particles) is applied to the display region E on the element substrate 51. As the applying method, for example, a dispenser is used. Furthermore, a die coater and the like may be also applied. The viscosity of silicone oil is, for example, 10 cP or less. An amount of the dispersion medium 15 is an amount of liquid that fills the inside surrounded by the frame edge partition wall 61 when bonding the element substrate 51 and the counter substrate 52. A height of the frame edge partition wall 61 is, for example, 10 μm to 50 μm.

Moreover, it is possible to prevent the first seal material 14a from entering (widening) on the side of the display region E by forming the frame edge partition wall 61. Furthermore, the width of the first seal material 14a may be regulated so as not to be wider than a predetermined width. Therefore, it is possible to ensure the strength of the first seal material 14a.

In step S33, as illustrated in FIG. 11E, bonding of the element substrate 51 and the counter substrate 52 is started. Moreover, in order to prevent air bubbles from entering the cell 36, the bonding is performed by pressing the substrates under a vacuum negative pressure environment. However, since the silicone oil is volatile, the silicone oil is in a low vacuum state lower than the atmospheric pressure. For example, the pressure is 500 Pa.

Furthermore, when bonding, it is possible to adjust the indentation amount of the top section 35′ of the partition wall 35 by heating the sealing film 62. Moreover, a temperature of the sealing film 62 when bonding is 50° C. to 60° C. A method for obtaining the heating temperature of the sealing film 62 will be described.

As a heating method of the sealing film 62, first, the counter substrate 52 including the sealing film 62 is mounted on a hot plate that is heated. Then, the sealing film 62 is in a state of being heated and softened.

In step S34, as illustrated in FIG. 11F, the dispersion medium 15 is sealed between the element substrate 51 and the counter substrate 52 (first sealing). That is, in a state of a low vacuum, the element substrate 51 and the counter substrate 52 are bonded through the first seal material 14a. At this time, the top section 35′ of the partition wall 35 is indented into the sealing film 62 that is softened. Therefore, as illustrated in FIG. 8, the sealing film 62 is plastically deformed and is solidified in a state of being deformed by cooling.

If the counter substrate 52 is pressed against the element substrate 51, the first seal material 14a is crushed and the dispersion medium 15 is pressed on the side of the frame edge partition wall 61 and the first seal material 14a, and is filled. At this time, the top section 35′ of the partition wall 35 provided in the display region E is indented into the sealing film 62 provided on the side of the counter substrate 52 so that it is possible to prevent the dispersion medium 15 from moving between the adjacent cells 36.

Thereafter, as illustrated in FIG. 11G, if the first seal material 14a is formed of an ultraviolet curing resin, the first seal material 14a is cured by irradiating ultraviolet rays. Furthermore, if the first seal material 14a is formed of a thermosetting resin, the first seal material 14a is cured by heating. When bonding the element substrate 51 and the counter substrate 52, the cell gap is approximately 20 μm to 50 μm, and is 30 μm in the embodiment. Furthermore, the width of the crushed first seal material 14a is, for example, 200 μm to 500 μm, and is 400 μm in the embodiment.

In step S35, as illustrated in FIG. 11H, in the atmosphere, the second seal material 14b is formed and adhered onto the outer periphery of the first seal material 14a (second sealing). Specifically, the second seal material 14b has a relatively low viscosity, where water does not enter, and it is important that the second seal material 14b enters the gap, and for example, the second seal material 14b is formed of acryl or epoxy resin. Moreover, the viscosity of the second seal material 14b is lower than that of the first seal material 14a by one level and is, for example, 100 Pa·s to 500 Pa·s, and is preferably 400 Pa·s. The width of the second seal material 14b is, for example, 400 μm.

As the applying method of the second seal material 14b, for example, a dispenser, a die coater, or the like is used. As described above, as illustrated in FIG. 11H, a space that is sandwiched by the element substrate 51 and the counter substrate 52 is sealed. Thereafter, the element substrate 51 and the counter substrate 52 are cut to a shape of a product to complete the electrophoretic apparatus 10 if necessary.

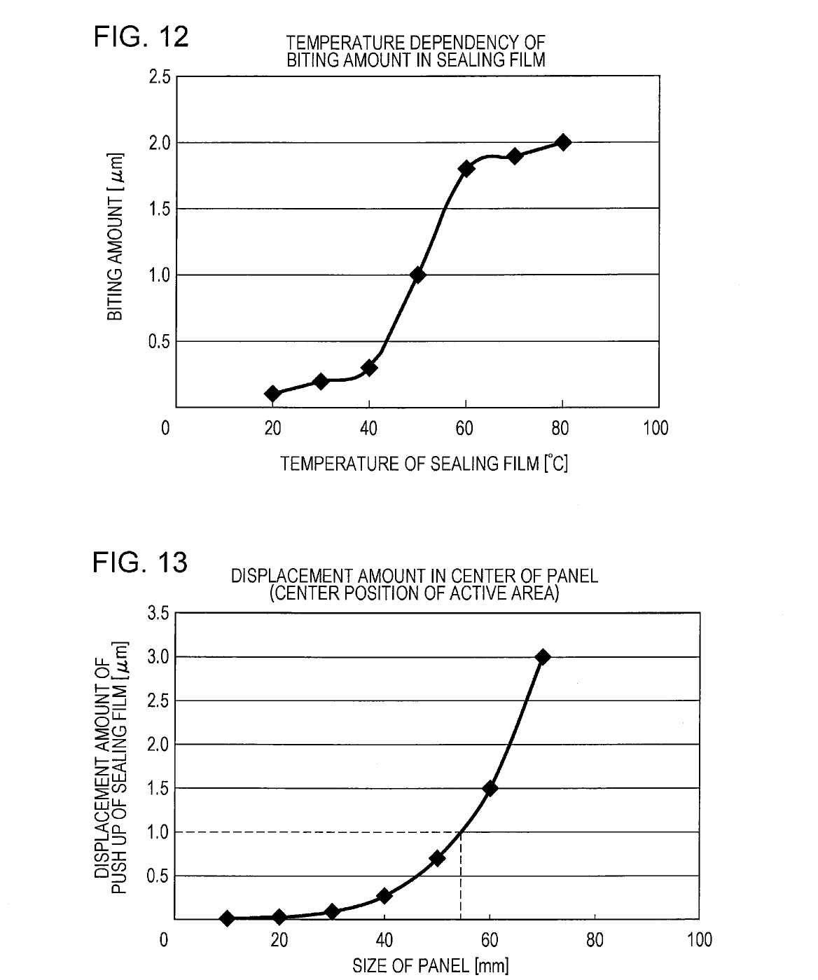

FIG. 12 is a graph illustrating temperature dependency of the indentation amount in the sealing film. Hereinafter, temperature dependency of the indentation amount in the sealing film will be described with reference to FIG. 12.

In the graph illustrated in FIG. 12, a horizontal axis is the temperature of the sealing film 62 and indicates 0° C. to 100° C. Meanwhile, a vertical axis is the indentation amount with respect to indenting into the sealing film 62 and indicates 0 μm to 2.5 μm.

Specifically, a relationship between the temperature of the sealing film 62 and the indentation amount is illustrated when the sealing film 62 (PVA) having the thickness of 5 μm is pushed into a rib structure of 5 μm that is the thickness of the partition wall 35. Moreover, a glass transition point (TG) of the material of the sealing film 62 is 50° C. to 60° C.

As described above, the material is plastically deformed at approximately 50° C. to 60° C., and the target is an indentation amount of 1.5 μm or more. In other words, when the top section 35′ of the partition wall 35 is indented approximately 1.5 μm into the sealing film 62 having the thickness of 5 μm, it is understood that it is sufficient to heat the sealing film 62 at the temperature of 50° C. to 60° C.

FIG. 13 is a graph illustrating a displacement amount near a center of the electrophoretic apparatus (panel). Hereinafter, the displacement amount near the center of the electrophoretic apparatus (panel) will be described with reference to FIG. 13.

In the graph illustrated in FIG. 13, a horizontal axis is a size of the panel and indicates 0 mm to 100 mm. Meanwhile, a vertical axis is the displacement amount of pushing up of the sealing film 62 and indicates 0 μm to 3.5 μm.

As specific experimental conditions, the thickness of the second base material 41 (glass substrate) of the counter substrate 52 is 0.5 mm. The viscosity of silicone oil is 20 cs or less. The thickness of the sealing film 62 is 5 μm. The environmental temperature is −30° C. to 85° C.

As described above, if one side of a panel is 55 mm or less, it is understood that the displacement amount of pushing up is in the target range even if the environmental temperature rises. In other words, if the panel size is 55 mm or more, the indentation amount of the partition wall 35 being indented into the sealing film 62 does not enter the target value due to thermal expansion of the dispersion medium 15, and a gap is formed between the sealing film 62 and the partition wall 35. As a result, it is not possible to suppress flowing of the dispersion medium 15 into the adjacent cell 36. The thicknesses of the element substrate 51 and the counter substrate 52 of the embodiment are respectively 0.5 mm, but the panel size can be increased to approximately 150 mm by thickening the thickness of the element substrate 51 or the counter substrate 52 or by reinforcing with a reinforcing plate. In addition, it is possible to form the panel without the gap between the sealing film 62 and the partition wall 35 even in the panel of A4 size by thickening the thickness of the sealing film 62 and by increasing the indentation amount of the top section 35′ of the partition wall 35.

As described above, the following effects are obtained according to the electrophoretic apparatus 10, the manufacturing method of the electrophoretic apparatus 10, and the electronic apparatus 100 of the first embodiment.

(1) According to the electrophoretic apparatus 10 of the first embodiment, since the top section 35′ of the partition wall 35 is sealed by the sealing film 62 having no adhesive property, it is possible to prevent the electrophoretic particles 34 from adhering to the sealing film 62 and to suppress deterioration of display quality.

(2) According to the electrophoretic apparatus 10 of the first embodiment, since the top section 35′ of the partition wall 35 enters (is indented into) the sealing film 62 that does not include an adhesive material, it is possible to prevent a gap from occurring between the top section 35′ and the sealing film 62 (in other words, the counter substrate 52), and to suppress moving of the dispersion medium 15 into the adjacent cell 36. Furthermore, since the sealing film 62 does not include the adhesive material, it is possible to prevent the impurities from dispersing in the dispersion medium 15 from the sealing film 62 and the impurities from adhering to the electrophoretic particles 34 and to suppress deterioration of display quality without affecting the electrophoresis property of the electrophoretic particles 34.

(3) According to the electrophoretic apparatus 10 of the first embodiment, since the concave section 62b and the top section 35′ are fitted, it is possible to prevent a gap from occurring between the concave section 62b (that is, the sealing film 62) and the top section 35′, and to suppress moving of the dispersion medium 15 into the adjacent cell 36.

(4) according to the electrophoretic apparatus 10 of the first embodiment, it is possible to operate the electrophoretic particles 34 included in the electrophoretic layer 33 and to suppress reducing of a switching speed by using silicone oil in the dispersion medium 15 even at a low temperature (for example, at approximately −30° C.)

(5) According to the manufacturing method of the electrophoretic apparatus 10 of the first embodiment, since the top section 35′ of the partition wall 35 is indented into the sealing film 62 that does not include an adhesive material by it being plastically deformed, it is possible to prevent a gap from occurring between the top section 35′ and the sealing film 62 (in other words, the counter substrate 52), and to suppress moving of the dispersion medium 15 into the adjacent cell 36. Furthermore, since the sealing film 62 does not include the adhesive material, it is possible to prevent the impurities from dispersing in the dispersion medium 15 from the sealing film 62 and the impurities from adhering to the electrophoretic particles 34, and to suppress deterioration of display quality without affecting the electrophoresis property of the electrophoretic particles 34.

(6) According to the manufacturing method of the electrophoretic apparatus 10 of the first embodiment, since the bonding of the element substrate 51 and the counter substrate 52 is performed at a pressure lower than the atmospheric pressure while heating the sealing film 62, it is possible for the top section 35′ of the partition wall 35 to be indented into the sealing film 62 and to manufacture the panel having no air bubbles.

(7) According to the electronic apparatus 100 of the first embodiment, since the electrophoretic apparatus 10 described above is included, it is possible to provide the electronic apparatus 100 in which deterioration of display quality is suppressed.

### Second Embodiment

### Structure of Electrophoretic Apparatus

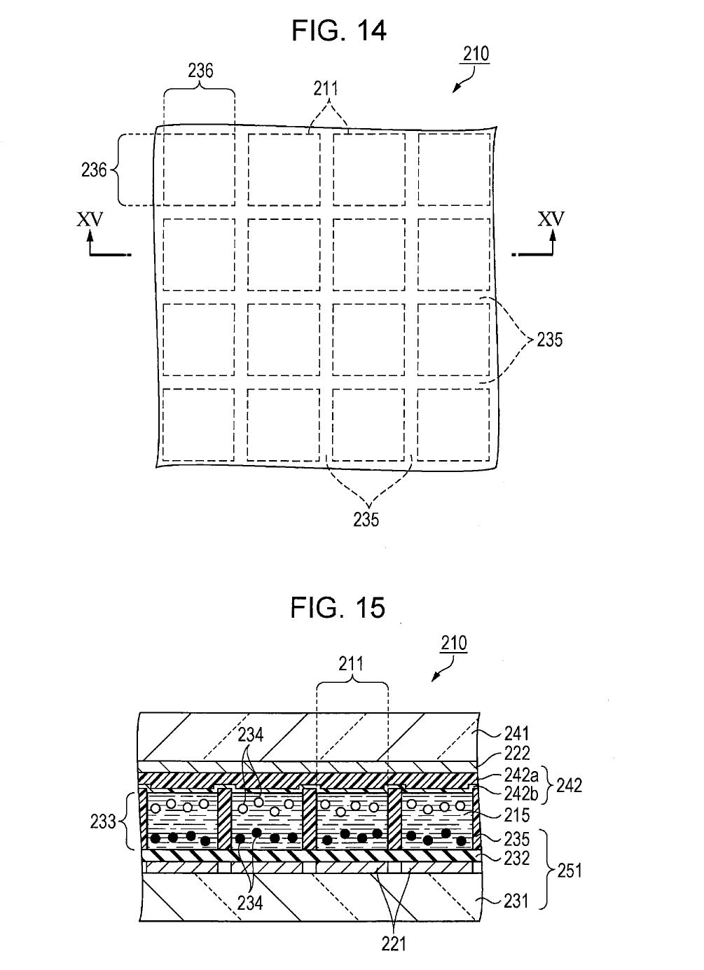

FIG. 14 is a schematic plan view illustrating a structure of an electrophoretic apparatus. FIG. 15 is a schematic cross-sectional view of the electrophoretic apparatus taken along line XV-XV illustrated in FIG. 14. Hereinafter, the structure of the electrophoretic apparatus will be described with reference to FIGS. 14 and 15.

As illustrated in FIGS. 14 and 15, an electrophoretic apparatus 210 has an element substrate 251 as a first substrate, a counter substrate 252 as a second substrate, and an electrophoretic layer 233. A pixel electrode 221 is disposed on a first base material 231 that configures the element substrate 251 and, for example, is formed of a glass substrate having translucency for each pixel 211.

More specifically, as illustrated in FIGS. 14 and 15, the pixel 211 (the pixel electrode 221) is, for example, formed in a matrix shape in a plan view. For example, as a material of the pixel electrode 221, a light transmitting material such as Indium Tin Oxide (ITO; indium oxide to which tin is added) is used.

A circuit section (not illustrated) is provided between the first base material 231 and the pixel electrode 221, and the TFT 16 and the like are formed in the circuit section. The TFT 16 is electrically connected to each pixel electrode 221 through a contact section (not illustrated). Moreover, even though not illustrated, various wirings (for example, the data line 12, the scanning line 13, or the like), an element (a capacitance element), or the like is disposed in the circuit section in addition to the TFT 16. A first insulation layer 232 is formed on an entire surface on the first base material 231 including the pixel electrode 221. Moreover, the first insulation layer 232 may not be provided.

A common electrode 222 provided commonly to the plurality of pixels 211 is formed on a second base material 241 (on the side of the dispersion medium 215 in FIG. 15) configuring the counter substrate 252, which is, for example, made from a glass substrate having translucency. For example, as the common electrode 222, a light transmitting material such as ITO is used.

A first sealing film 242a is formed on the common electrode 222. A second sealing film 242b is disposed on the first sealing film 242a. Moreover, combination of the first sealing film 242a and the second sealing film 242b is referred to as a sealing film 242.

The electrophoretic layer 233 is provided between the first insulation layer 232 and the sealing film 242. The dispersion medium 215 in which at least one or more electrophoretic particles 234 configuring the electrophoretic layer 233 are dispersed is filled into a space partitioned by the first insulation layer 232, the second sealing film 242b, and partition walls 235 (ribs) provided on the first base material 231.

As illustrated in FIG. 14, the partition walls 235 are formed in a grid shape. Moreover, the partition wall 235 is preferably formed in a translucent material (acryl, epoxy resin, or the like). For example, a width of the partition wall 235 is 5 μm. In the example, the pixel electrode 221 is disposed for each pixel 211 and the partition wall 235 (rib) is disposed for each pixel electrode 221, but the invention is not limited to the example and the partition wall (rib) may be formed for a plurality of pixels, for example, for 2 to 20 pixels.

Furthermore, when bonding the element substrate 251 and the counter substrate 252, it is possible to determine a cell gap between the element substrate 251 and the counter substrate 252 relative to a height (really, a frame edge partition wall 261 illustrated in FIG. 17) of the partition wall 235 by contacting an upper section of the partition wall 235 with the counter substrate 252 (specifically, the sealing film 242). The height of the partition wall 235 is, for example, 30 μm.

White particles and black particles are illustrated in FIG. 15, as the electrophoretic particles 234. For example, when a voltage is applied between the pixel electrode 221 and the common electrode 222, according to an electric field generated therebetween, the electrophoresis of the electrophoretic particles 234 is performed toward either electrode (the pixel electrode 221 and the common electrode 222). For example, if the white particles have a positive charge and the pixel electrode 221 has a negative potential, the white particles are moved to and collected on the side (lower side) of the pixel electrode 221, and become a black display.

On the contrary, if the pixel electrode 221 has a positive potential, the white particles are moved to and collected on the side (upper side) of the common electrode 222, and become a white display. As described above, desired information (image) is displayed depending on presence or absence, the number, or the like of the white particles collected at the electrodes on the sides of the display. Moreover, here, the white particles or the black particles are used as the electrophoretic particles 234, but other color particles may be used.

Furthermore, as the electrophoretic particles 234, it is possible to use particles of inorganic pigment, particles of organic pigment, polymeric microparticles, or the like, and to use particles into which various particles of two types or more are mixed. For example, a diameter of the electrophoretic particles 234 is approximately 0.05 μm to 10 μm and preferably is approximately 0.2 μm to 2 μm.

Furthermore, a content of the white particles is within 30% relative to a total weight of the dispersion medium 215, the white particles, and the black particles and a content of the black particles is within 10% relative to the total weight of the dispersion medium 215, the white particles, and the black particles. Reflectance is 40% or more and the black reflectance is 2% or less, and it is possible to increase display performance by distributing as described above.

In the embodiment, as the dispersion medium 215, silicone oil in which the electrophoretic particles 234 are movable even at a temperature of approximately −30° C. is used. However, since in the silicone oil, a surface energy is low and a cohesive strength is low because a surface of a molecule is covered with methyl groups, an adhesive strength by seal materials 214a and 214b may be remarkably lowered by attaching the silicone oil to the seal materials 214a and 214b. For example, viscosity of the silicone oil is 10 cP or less. Since the silicone oil is a low-viscosity solvent, for example, the electrophoresis of the electrophoretic particles can be performed between the electrodes at a speed of 500 ms or less even at a temperature of approximately −30° C.

Moreover, hereinafter, a region surrounded by the partition walls 235 is referred to as a cell 236. One cell 236 includes the pixel electrode 221, the common electrode 222, and the electrophoretic layer 233.

### Structure of Sealing Film and Periphery of Seal Section

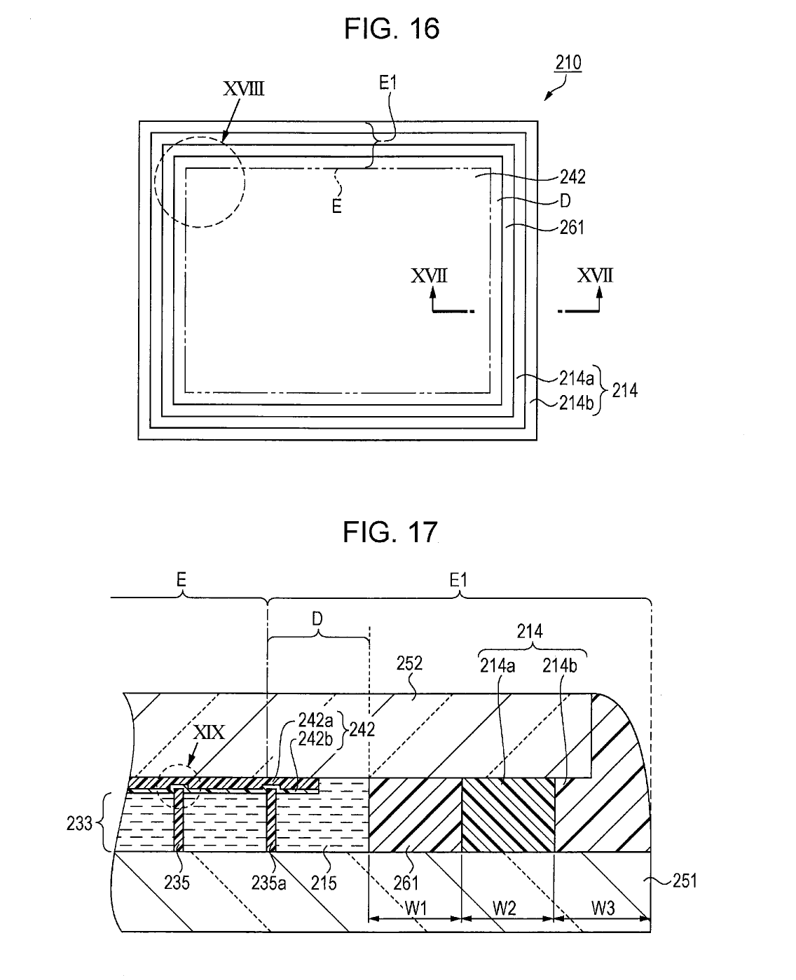

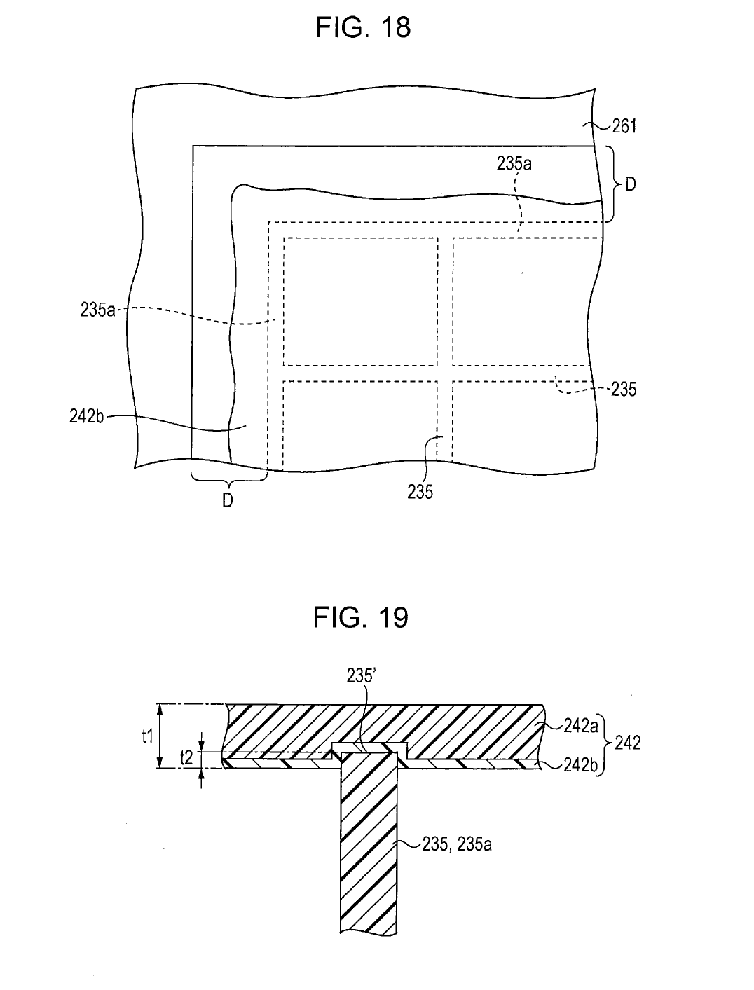

FIG. 16 is a schematic plan view illustrating a structure of a sealing film and a periphery of a seal section in the electrophoretic apparatus. FIG. 17 is a schematic cross-sectional view of the electrophoretic apparatus taken along line XVII-XVII illustrated in FIG. 16. FIG. 18 is an enlarged plan view illustrating an XVIII portion of the electrophoretic apparatus illustrated in FIG. 16 by enlargement. FIG. 19 is an enlarged cross-sectional view illustrating an F portion of the electrophoretic apparatus illustrated in FIG. 17 by enlargement. Hereinafter, the structure of the sealing film and the periphery of the seal section of the electrophoretic apparatus will be described with reference to FIGS. 16 to 19. Moreover, illustration of the insulation layer, the wirings, the electrodes, and the like are omitted.

As illustrated in FIGS. 16 and 17, the electrophoretic apparatus 210 has a frame edge region E1 so as to surround the display region E. The frame edge region E1 includes a dummy pixel region D that does not contribute to the display of the electrophoretic layer 233, the frame edge partition wall 261 that is disposed on the outside of the dummy pixel region D, and a seal section 214 that is disposed on the outside of the frame edge partition wall 261. A width of the frame edge region E1 is, for example, approximately 1 mm.

A width of the dummy pixel region D is, for example, 80 μm. A partition wall 235a that is formed in the same shape as the partition wall 235 disposed in the display region E is provided on side of the display region E of the dummy pixel region D. A rib width (width of a top section 235′) of the partition wall is 3 μm to 10 μm and is 5 μm in the embodiment. A distance between adjacent partition walls is, for example, 150 μm.

The frame edge partition wall 261 is provided on the outside of the dummy pixel region D. The frame edge partition wall 261 can intercept the dispersion medium 215 so that it does not flow out to the outside and is used to adjust the cell gap, and is disposed so as to surround the dummy pixel region D. Moreover, the frame edge partition wall 261 is configured of the same material as that of the partition wall 235 of the display region E.

A width W1 of the frame edge partition wall 261 is, for example, 100 μm. A thickness of the frame edge partition wall 261 is, for example, in a range of 10 μm to 50 μm. The thickness thereof is 33 μm in the embodiment. Moreover, the frame edge partition wall 261 is also used for a first seal material 214a disposed adjacent to the frame edge partition wall 61 to not protrude in the display region E.

The seal section 214 has the first seal material 214a and a second seal material 214b. The first seal material 214a is provided for adhering when bonding the element substrate 251 and the counter substrate 252, and is provided to surround the frame edge partition wall 261. A width W2 of the first seal material 214a is, for example, 400 μm. The viscosity of the first seal material 214a is, for example, 300000 Pa·s to 1000000 Pa·s. Preferably, the viscosity thereof is approximately 400000 Pa·s. It is possible to maintain a contact area between the element substrate 251 and the counter substrate 252 by using the first seal material 214a having such a viscosity when bonding.

The second seal material 214b is used for sealing between the element substrate 251 and the counter substrate 252, and is disposed so as to surround the first seal material 214a. A width w3 of the second seal material 214b is, for example, 400 μm. A viscosity of the second seal material 214b is, for example, 100 Pa·s to 500 Pa·s. Preferably, the viscosity thereof is approximately 400 Pa·s. It is possible to introduce the second seal material 214b between the element substrate 251 and the counter substrate 252 of the periphery of the first seal material 214a and to improve the adhesive strength of the second seal material 214b by using the second seal material 214b having such a viscosity.

Furthermore, it is possible to suppress entering of moisture to the inside from the outside through the second seal material 214b and the first seal material 214a and to obtain a highly reliable seal structure.

As illustrated in FIGS. 17 and 19, the sealing film 242 is provided between the top section 235′ of the partition wall 235 at least in the display region E and the counter substrate 252 so that the dispersion medium 215 or the electrophoretic particles 234 are prevented from coming and going between the adjacent cells 236. A thickness t1 of the sealing film 242 is satisfactory as long as the electric field is not disturbed, and is preferably, for example, 2.6 μm to 8 μm. The thickness thereof is 5 μm in the embodiment. The top section 235′ of the partition wall 235 is indented into the sealing film 242.

In other words, when comparing in a cross-sectional view, a portion that overlaps with the partition wall 235 among the contact surface between the first sealing film 242a and the second sealing film 242b in a plan view, and a portion that does not overlap with the partition wall 235 in a plan view, the portion that overlaps with the partition wall 235 in a plan view is positioned nearer to the side of the second base material 241 than the portion that does not overlap.

Furthermore, when comparing a portion (a portion that does not overlap with the partition wall 235 in a plan view) into which the top section 235′ is not indented into the contact surface between the first sealing film 242a and the second sealing film 242b, and the top section 235′, as illustrated in FIG. 19, the top section 235′ is preferably positioned on the side of the second base material 241. An indentation amount t2 of the partition wall 235 into the sealing film 242, that is, a distance between a portion into which the top section 235′ is not indented into the surface of the second sealing film 242b on the side of the electrophoretic layer 233, and the top section 235′ is preferably, for example, 1 μm to 5 μm, and is 2 μm in the embodiment.

Specifically, as illustrated in FIG. 15, the first sealing film 242a and the second sealing film 242b are laminated in this order from the side of the counter substrate 252. The thickness of the first sealing film 242a is preferably 2.5 μm to 7.5 μm and the thickness of the second sealing film 242b is preferably 0.05 μm to 0.5 μm. The thickness of the first sealing film 242a is 4.5 μm and the thickness of the second sealing film 242b is 0.5 μm in the embodiment. The element substrate 251 and the counter substrate 252 are bonded so that the top section 235′ of the partition wall 235 is indented into the first sealing film 242a and the second sealing film 242b.

The first sealing film 242a is formed using a material softer (elastic modulus is low) than that of the second sealing film 242b in the embodiment and detailed description thereof will be described. In this case, it is possible for the top section 235′ of the partition wall 235 to be indented (the sealing film 242 is deformed by the top section 235′ of the partition wall 235) into the sealing film 242 without bending the top section 235′ or damaging (the second sealing film is broken by the top section 235′) the second sealing film by setting the film thickness of the first sealing film 242a and the second sealing film 242b as described above, even if the width of the top section 235′ of the partition wall 235 is as thin as 3 μm to 10 μm.

The first sealing film 242a is formed of a material which is softer than that of the second sealing film 242b described below and into which the top section 235′ of the partition wall 235 is easily indented. As the material of the first sealing film 242a, for example, acrylonitrile•butadiene rubber (NBR) is used. The elastic modulus of the first sealing film 242a is preferably 5 MPa to 40 MPa. In the embodiment, the first sealing film 242a is formed by using NBR of which the elastic modulus is 20 MPa at room temperature.

Moreover, as the material of the first sealing film 242a, it is also possible to use urethane, isoprene, butadiene, chloroprene, and styrene•butadiene rubber.

For example, the second sealing film 242b is used such that the first sealing film 242a does not elute into the dispersion medium 215. As the material of the second sealing film 242b, a material of which interaction with the electrophoretic particles 234 or the dispersion medium 215 is small is preferably used and, for example, polyvinyl alcohol (PVA) is used. The elastic modulus of the second sealing film 242b is preferably 50 MPa to 600 MPa. It is possible for the top section 235′ of the partition wall 235 to be indented (the sealing film 242 is deformed by the top section 235′ of the partition wall 235) into the sealing film 242 without bending the top section 235′ of the partition wall 235 or damaging the second sealing film by forming the first sealing film 242a and the second sealing film 242b by using the materials having the elastic moduluses described above.

Furthermore, as the material of the second sealing film 242b, a non-polar polymer is preferably used and, for example, polyethylene or polypropylene may be used. Since the materials has a small risk of eluting into the dispersion medium 215, it is possible to appropriately reduce defects of the electrophoretic apparatus 210. Furthermore, the material of the second sealing film 242b preferably has a low or no adhesive property. Therefore, it is possible to prevent the electrophoretic particles 234 from fixing to the second sealing film 242b.

Furthermore, an additive softening (lowering the elastic modulus of the second sealing film 242b) the material of the second sealing film 242b may be included in the second sealing film 242b. As the additive, for example, glycerin is used. The additive is preferably adding 5 wt % to 50 wt % with respect to a solid content of PVA. Therefore, it is possible to use the material as the second sealing film 242b even if a material having an elastic modulus of 600 MPa or more is selected as the material of the second sealing film. In the embodiment, as the material of the second sealing film 242b, a material is used in which glycerin is added to PVA of which the elastic modulus is 692 MPa at room temperature and of which the elastic modulus is 75 MPa at room temperature.

Furthermore, the additive is not limited to glycerin and, for example, a mixture of one type or two types or more selected from polyethylene glycols, glycerine, urea, polyethylene oxide, and polypropylene glycol may be used.

Furthermore, regarding light transmittance of the sealing film 242, this is PVA is 99% for PVA and 99% for NBR. Furthermore, the volume resistivity of the first sealing film 242a is preferably 1×10⁷ Ω·cm to 5×10¹⁰ Ω·cm and the volume resistivity of the second sealing film 242b is preferably 1×10⁷ Ω·cm to 2×10¹¹ Ω·cm.

As described above, the top section 235′ of the partition wall 235 is indented into the sealing film 242 so that it is possible to suppress the gap from occurring between the sealing film 242 and the partition wall 235. As a result, it is possible to suppress flowing of the dispersion medium 215 into the adjacent cell 236.

As illustrated in FIGS. 17 and 18, an end section of the sealing film 242 is, for example, disposed between the outermost partition wall 235a of the display region E and the frame edge partition wall 261, that is, in a range of the dummy pixel region D. The sealing film 242 is sized slightly larger than the display region E and is sized such that the end section does not enter the display region E even if variation occurs in the size.

If the adhesive is used as the material forming the sealing film 242, the adhesive (for example, impurities such as reactive monomer that is not fully cured) contained in the adhesive layer is eluted into the dispersion medium so that there is a concern that the adhesive is adhered to the electrophoretic particles 234 included in dispersion liquid and may affect the electrophoresis property of the electrophoretic particles 234. However, in the embodiment, since the second sealing film 242b is disposed in a portion with which the electrophoretic particles 234 come into contact, it is possible to reduce such a problem.

Furthermore, in a case where the sealing film 242 is formed of only a material having a high elastic modulus (stiff), if the width of the top section 235′ of the partition wall 235 is narrow, there is a concern that the top section 235′ is not indented into the sealing film 242 and be bent. Then, it is considered that a gap occurs between the top section 235′ of the partition wall 235 and the sealing film 242, and the electrophoretic particles 234 move between adjacent cells 236. However, it is possible to suppress such a problem by forming the sealing film 242 with the first sealing film 242a and the second sealing film 242b as in the embodiment and by setting the elastic modulus or the film thickness in a suitable range, respectively. Hereinafter, a manufacturing method of the electrophoretic apparatus 210 will be described.

### Manufacturing Method of Electrophoretic Apparatus

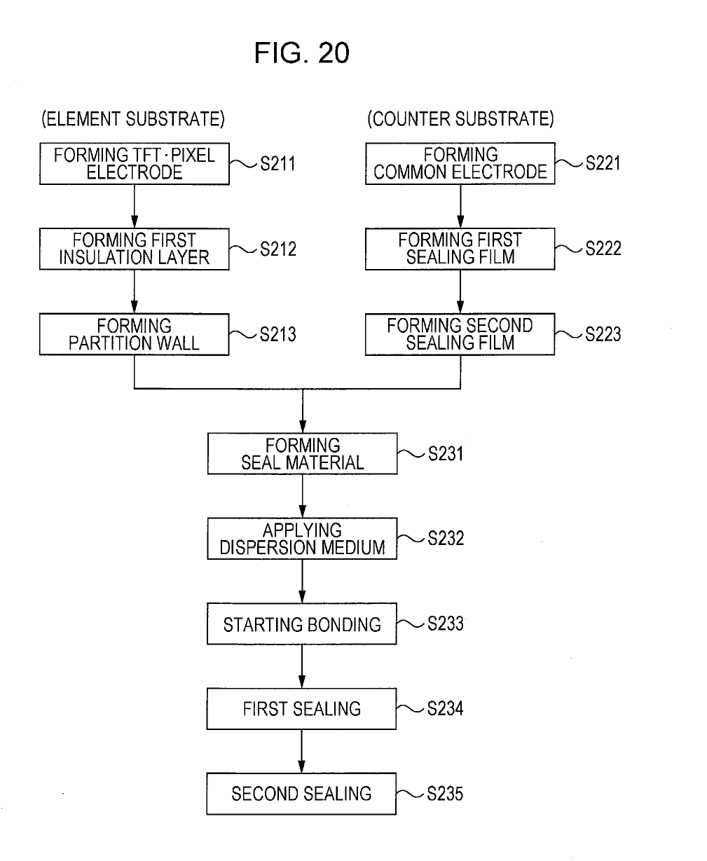

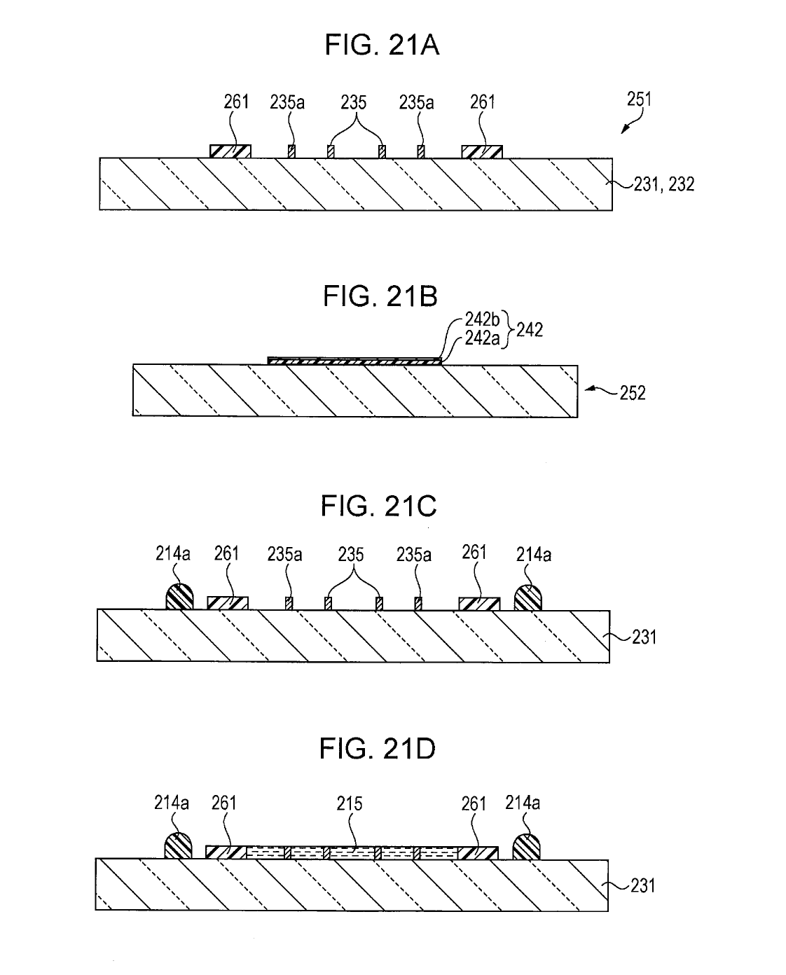

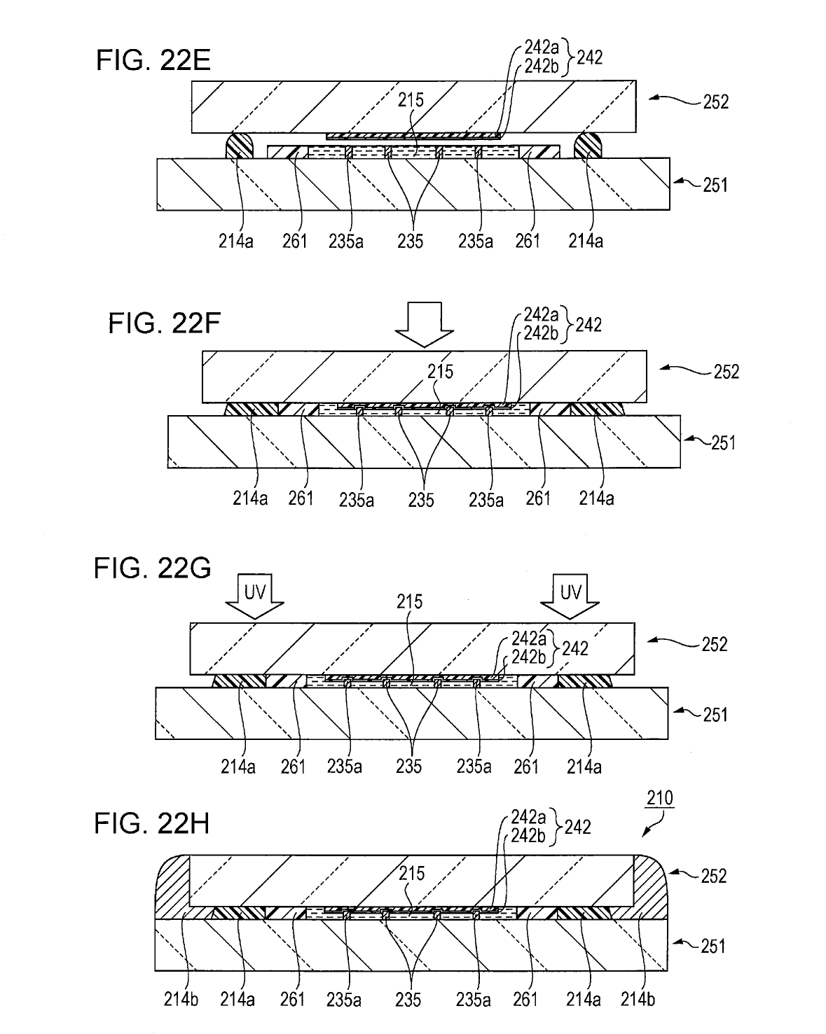

FIG. 20 is a flowchart illustrating a manufacturing method of the electrophoretic apparatus in order of steps. FIGS. 21A to 21D and 22E to 22H are schematic cross-sectional views illustrating a part of the manufacturing method in the manufacturing method of the electrophoretic apparatus. Hereinafter, the manufacturing method of the electrophoretic apparatus will be described with reference to FIGS. 20, 21A to 21D, and 22E to 22H.

First, the manufacturing method of the element substrate 251 is described with reference to FIG. 20. In step S211, the TFT 16, the pixel electrode 221 formed of a light transmitting material such as ITO, or the like is formed on the first base material 231 formed of a translucent material such as glass. Specifically, the TFT 16, the pixel electrode 221, and the like are formed on the first base material 231 by using known film deposition techniques, photolithography techniques and etching techniques. Moreover, in the following description using the cross-sectional views, description and illustration of the TFT 16, the pixel electrode 221, or the like are omitted.

In step S212, the first insulation layer 232 is formed on the first base material 231. As a manufacturing method of the first insulation layer 232, for example, an insulation material is applied on the first base material 231 using a spin coat method and the like, and then it is possible to form the first insulation layer 232 by drying the insulation material.

In step S213, as illustrated in FIG. 21A, the partition wall 235 is formed on the first base material 231 (specifically, the first insulation layer 232). Specifically, the partition wall 235 of the display region E, the partition wall 235a of the outermost periphery of the display region E, and the frame edge partition wall 261 provided on the outside thereof are simultaneously formed. For example, the partition walls 235 and 235a, and the frame edge partition wall 261 can be formed by using known film deposition techniques, photolithography techniques and etching techniques.

As described above, it is possible to efficiently manufacture the partition walls 235 and 235a, and the frame edge partition wall 261 by simultaneously forming with the same material. As described above, the element substrate 251 is completed.

The partition wall 235 is formed of a material that is insoluble in the dispersion medium 215, and it does not matter whether the material thereof is inorganic or organic matter. Specifically, as examples of the organic material, urethane resin, urea resin, acrylic resin, polyester resin, silicone resin, acryl silicone resin, epoxy resin, polystyrene resin, styrene acrylic resin, polyolefin resin, butyral resin, vinylidene chloride resin, melamine resin, phenol resin, fluorine resin, polycarbonate resin, polysulfone resin, polyether resin, polyamide resin, polyimide resin or the like may be exemplified. A single body or a combined body of two types or more resins are used.

Subsequently, a manufacturing method of the counter substrate 252 will be described. In step S221, the common electrode 222 is formed on the second base material 241. Specifically, the common electrode 222 is formed on an entire surface on the second base material 241 formed of the translucent material such as a glass substrate by using known film deposition techniques.

In step S222 and step S223, the first sealing film 242a and the second sealing film 242b are formed on the common electrode 222. As illustrated in FIG. 21B, as a forming method of the first sealing film 242a and the second sealing film 242b, for example, acrylonitrile butadiene rubber (NBR) is deposited on the counter substrate 252 by using an applying method such as spin coating, and then polyvinyl alcohol (PVA) is deposited similarly by using an applying method.

As described above, an additive such as glycerin is added to the PVA. Next, the PVA and the NBR are patterned by using an etching method and then the first sealing film 242a and the second sealing film 242b are formed. Moreover, the films may be formed by using a printing method in addition to the applying method. As described above, the counter substrate 252 is completed.

Subsequently, a bonding method between the element substrate 251 and the counter substrate 252 will be described with reference to FIGS. 20, 21A to 21D, and 22E to 22H.

First, in step S231, as illustrated in FIG. 21C, the first seal material 214a is applied on an outer periphery of the frame edge partition wall 261 in the atmosphere. For example, a material of the first seal material 214a is Kayatoron that is one-part liquid epoxy resin having relatively high viscosity. The viscosity of the first seal material 214a is, for example, 300000 Pa·s to 1000000 Pa·s. Preferably, the viscosity thereof is 400000 Pa·s. A width of the first seal material 214a when applied is a width sufficient to withstand a vacuum and, for example, is 400 μm.

In step S232, as illustrated in FIG. 21D, the dispersion medium 215 formed of silicone oil including the electrophoretic particles 234 (the white particles and the black particles) is applied to the display region E on the element substrate 251. As the applying method, for example, a dispenser is used. Furthermore, a die coater and the like may be also applied. The viscosity of silicone oil is, for example, 10 cP or less. An amount of the dispersion medium 215 is an amount of liquid that fills the inside surrounded by the frame edge partition wall 261 when bonding the element substrate 251 and the counter substrate 252. In the embodiment, a height of the frame edge partition wall 261 is, for example, 33 μm.

Moreover, it is possible to prevent the first seal material 214a from entering (widening) on the side of the display region E by forming the frame edge partition wall 261. Furthermore, the width of the first seal material 214a may be regulated so as not to be wider than a predetermined width. Therefore, it is possible to ensure the strength of the first seal material 214a.

In step S233, as illustrated in FIG. 22E, bonding of the element substrate 251 and the counter substrate 252 is started. Moreover, in order to prevent air bubbles from entering the cell 236, the bonding is performed by pressing the substrates under a vacuum negative pressure environment. However, since the silicone oil is volatile, the silicone oil is in a low vacuum state lower than the atmospheric pressure. For example, the pressure is 500 Pa.

In step S234, as illustrated in FIG. 22F, the dispersion medium 215 is sealed between the element substrate 251 and the counter substrate 252 (first sealing). That is, in a state of a low vacuum, the element substrate 251 and the counter substrate 252 are bonded through the first seal material 214a. At this time, until the top section 235′ of the partition wall 235 is indented into the sealing film 242, in other words, when comparing in a cross-sectional view, a portion that overlaps with the partition wall 235 among the contact surface between the first sealing film 242a and the second sealing film 242b in a plan view, and a portion that does not overlap with the partition wall 235 in a plan view, until the portion that overlaps with the partition wall 235 in a plan view is positioned nearer to the side of the second base material 241 than the portion that does not overlap, the counter substrate 252 is continuously pressed against the element substrate 251. At this time, the frame edge partition wall 261 also functions as a spacer that defines a cell gap between the element substrate 251 and the counter substrate 252.

If the counter substrate 252 is pressed against the element substrate 251, the first seal material 214a is crushed and the dispersion medium 215 is pressed to the side of the frame edge partition wall 261 and the first seal material 214a, and is filled. At this time, the top section 235′ of the partition wall 235 provided in the display region E is indented into the sealing film 242 provided on the side of the counter substrate 252 so that it is possible to prevent the dispersion medium 215 from moving between the adjacent cells 236.

Thereafter, as illustrated in FIG. 22G, if the first seal material 214a is formed of an ultraviolet curing resin, the first seal material 214a is cured by irradiating ultraviolet rays. Furthermore, if the first seal material 214a is formed of a thermosetting resin, the first seal material 214a is cured by heating. When bonding the element substrate 251 and the counter substrate 252, the cell gap is approximately 20 μm to 50 μm, and is 33 μm in the embodiment. Furthermore, the width of the crushed first seal material 14a is, for example, 200 μm to 500 μm, and is 400 μm in the embodiment.

In step S235, as illustrated in FIG. 22H, in the atmosphere, the second seal material 214b is formed and adhered onto the outer periphery of the first seal material 214a (second sealing). Specifically, the second seal material 214b has a relatively low viscosity, where water does not enter, and it is important that the second seal material 214b enters the gap, and for example, the second seal material 214b is formed of acryl or epoxy resin. Moreover, the viscosity of the second seal material 214b is lower than that of the first seal material 214a and is, for example, 100 Pa·s to 500 Pa·s, and is preferably 400 Pa·s. The width of the second seal material 214b is, for example, 400 μm.

As the applying method of the second seal material 214b, for example, a dispenser, a die coater, or the like is used. As described above, as illustrated in FIG. 22H, a space that is sandwiched by the element substrate 251 and the counter substrate 252 is sealed. Thereafter, the element substrate 251 and the counter substrate 252 are cut to a shape of a product to complete the electrophoretic apparatus 210, if necessary.

As described above, the following effects are obtained according to the manufacturing method of the electrophoretic apparatus 210, and the electrophoretic apparatus 210 of the second embodiment.

(8) According to the manufacturing method of the electrophoretic apparatus 210 of the second embodiment, since the top section 235′ of the partition wall 235 is indented into the first sealing film 242a and the second sealing film 242b, it is possible to prevent a gap from occurring between the top section 235′ and the sealing film 242 (the first sealing film 242a and the second sealing film 242b), and to suppress moving of the dispersion medium 215 into the adjacent cell 236. Furthermore, since, for example, the first sealing film 242a (a material having a high adhesive property) is formed on the side that does not come into contact with the dispersion medium 215, and the second sealing film 242b is formed on the side that comes into contact with the dispersion medium 215 by forming the sealing film 242 with two layers (the first sealing film 242a and the second sealing film 242b), it is possible to prevent the electrophoretic particles 234 from adhering to the sealing film 242 and to suppress deterioration of display quality.

(9) According to the manufacturing method of the electrophoretic apparatus 210 of the second embodiment, since the thickness of the first sealing film 242a that is soft is thick and the film thickness of the second sealing film 242b that is hard is thin, the top section 235′ of the partition wall 235 can be indented into the first sealing film 242a and the second sealing film 242b, and it is possible to prevent a gap from occurring between the top section 235′ and the sealing film 242 (the first sealing film 242a and the second sealing film 242b). As a result, it is possible to suppress moving of the dispersion medium 215 into the adjacent cell 236 and to suppress adhering of the electrophoretic particles 234 to the sealing film 242.

(10) According to the manufacturing method of the electrophoretic apparatus 210 of the second embodiment, the top section 235′ of the partition wall 235 can be indented into the sealing film 242 more simply than a case where the sealing film 242 is formed of only a material having a high elastic modulus. Specifically, when the top section 235′ of the partition wall 235 is indented into the sealing film 242, for example, it is not necessary to heat the sealing film 242 to decrease the elastic modulus of the sealing film 242.

(11) According to the manufacturing method of the electrophoretic apparatus 210 of the second embodiment, since the top section 235′ of the partition wall 235 is indented into the first sealing film 242a and the second sealing film 242b, it is possible to prevent a gap from occurring between the top section 235′ and the sealing film 242, and to suppress moving of the dispersion medium 215 into the adjacent cell 236. Furthermore, since, for example, the first sealing film 242a (the material having a high adhesive property) is disposed on the side that does not come into contact with the dispersion medium 215, and the second sealing film 242b is disposed on the side that comes into contact with the dispersion medium 215 by forming the sealing film 242 with two layers (the first sealing film 242a and the second sealing film 242b), it is possible to prevent the electrophoretic particles 234 from adhering to the sealing film 242 and to suppress deterioration of display quality.

Moreover, the aspect of the invention is not limited to the embodiments described above and may be appropriately changed within a range that is not contrary to the gist or the spirit of the invention which can be read from the claims and the entire specification, and the change is intended to be included within the scope of the aspect of the invention. Furthermore, it can also be embodied in the following aspects.

### Modification Example 1

A sealing function may be sufficiently provided, only the first seal material 14a may be disposed, and only the second seal material 14b may be disposed instead of disposing two seal materials of the first seal material 14a and the second seal material 14b as the seal section 14 as in the first embodiment described above. Furthermore, a sealing function may be sufficiently provided, only the first seal material 214a may be disposed, and only the second seal material 214b may be disposed instead of disposing two seal materials of the first seal material 214a and the second seal material 214b as the seal section 214 as in the second embodiment described above.

### Modification Example 2

The aspect of the invention is not limited to the case where the frame edge partition wall 61 having the width W1 of 150 μm is disposed as in the first embodiment described above, the function as the partition wall may be provided and, for example, a partition wall similar to the partition wall 35 disposed in the display region E may be disposed. Furthermore, the aspect of the invention is not limited to the case where the frame edge partition wall 261 having the width W1 of 100 μm is disposed as in the second embodiment described above, the function as the partition wall may be provided and, for example, a partition wall similar to the partition wall 235 disposed in the display region E may be disposed.

### Modification Example 3

The aspect of the invention is not limited to the case where the partition wall 35 or the frame edge partition wall 61 is disposed on the side of the element substrate 51 as in the first embodiment described above, the partition wall 35 or the frame edge partition wall 61 may be disposed on the side of the counter substrate 52. Furthermore, the aspect of the invention is not limited to the case where the partition wall 235 or the frame edge partition wall 261 is disposed on the side of the element substrate 251 as in the second embodiment described above, the partition wall 235 or the frame edge partition wall 261 may be disposed on the side of the counter substrate 252.

### Modification Example 4

The shape of the cells 36 and 236 surrounded by the partition walls 35 and 235 is not limited to the lattice shape in a plan view as in the first and second embodiments described above, and, for example, the shape may be a honeycomb shape (hexagonal). Moreover, the shape is not limited to the lattice shape or the honeycomb shape, and may be shapes such as a polygonal shape, a round shape and a triangular shape.

### Modification Example 5

The aspect of the invention is not limited to the case where the partition walls 35 and 235 are formed by using the photolithography method as in the first and second embodiments described above, and, for example, the partition walls 35 and 235 may be formed by using a printing process such as a nanoimprint method, a screen printing method, a relief printing method, or a gravure printing method.

### Modification Example 6

The first base materials 31 and 231, and the second base material 41 and 241 may be formed by using the material having the light transmission property on the display side as in the first and second embodiments described above, and may be formed by using a plastic substrate in addition to the glass substrate.

### Modification Example 7

The aspect of the invention is not limited to the case where the frame edge partition wall 261 is used as the spacer as in the second embodiment described above. In order to define the cell gap between the element substrate 251 and the counter substrate 252, for example, if another member is provided as the spacer, the height of the frame edge partition wall 261 may be the same as that of the partition wall 235.

What is claimed is:

1. An electrophoretic apparatus comprising:
a first substrate;
a second substrate that is disposed to face the first substrate;
an electrophoretic layer that is disposed between the first substrate and the second substrate, and has a dispersion medium in which electrophoretic particles are dispersed;
a partition wall that is disposed to separate the electrophoretic layer into a plurality of cells;
a seal material that bonds the first substrate and the second substrate, and is disposed so as to surround the electrophoretic layer; and
a sealing film that is disposed at least between the partition wall and the second substrate, and has a low adhesive force,
wherein a top section of the partition wall is disposed in the sealing film.

2. The electrophoretic apparatus according to claim 1,
wherein the sealing film does not include an adhesive material.

3. The electrophoretic apparatus according to claim 1,
wherein a size of one side of a display region of the electrophoretic layer is 55 mm or less.

4. The electrophoretic apparatus according to claim 3,
wherein a dummy pixel region that does not contribute to display is provided around the display region, and
wherein an end section of the sealing film overlaps with the dummy pixel region in a plan view.

5. The electrophoretic apparatus according to claim 1,
wherein the sealing film includes a first sealing film that is disposed between the partition wall and the second substrate, and a second sealing film that is disposed between the first sealing film and the partition wall, and
wherein a portion of a contact surface between the first sealing film and the second sealing film, which overlaps with the partition wall in a plan view is positioned nearer to the side of the second substrate in a cross-sectional view, than a portion which does not overlap with the partition wall in a plan view.

6. The electrophoretic apparatus according to claim 5,
wherein an elastic modulus of the first sealing film is 5 MPa or more and 40 MPa or less, and
wherein an elastic modulus of the second sealing film is 50 MPa or more and 600 MPa or less.

7. The electrophoretic apparatus according to claim 5,
wherein a film thickness of the first sealing film is 2.5 μm or more and 7.5 μm or less, and
wherein a film thickness of the second sealing film is 0.05 μm or more and 0.5 μm or less.

8. The electrophoretic apparatus according to claim 5,
wherein an amount of an additive to be added to the first sealing film is 5 wt % or more and 50 wt % or less in a solid content of the first sealing film.

9. The electrophoretic apparatus according to claim 5,
wherein a volume resistivity of the first sealing film is 1×10⁷ Ω·cm or more and 5×10 Ω·cm or less, and
wherein a volume resistivity of the second sealing film is 1×10⁷ Ω·cm or more and 2×10¹¹ Ω·cm or less.

10. A manufacturing method of an electrophoretic apparatus, comprising:
forming a partition wall on a first substrate to separate a dispersion medium including electrophoretic particles into a plurality of cells;
applying a seal material around a display region of the first substrate;
forming a sealing film having a low adhesive force on a second substrate that is disposed to face the first substrate;
supplying the dispersion medium in the display region of the first substrate; and
bonding the first substrate and the second substrate through the seal material and causing a top section of the partition wall to be indented into the sealing film.

11. The manufacturing method of an electrophoretic apparatus according to claim 10,
wherein the sealing film is formed of a material that does not include an adhesive material.

12. The manufacturing method of an electrophoretic apparatus according to claim 10,
wherein the bonding of the first substrate and the second substrate is performed under a pressure lower than atmospheric pressure while heating the sealing film.

13. The manufacturing method of an electrophoretic apparatus according to claim 10,
wherein the forming of the sealing film includes
forming a first sealing film on the second substrate that is disposed to face the first substrate, and
forming a second sealing film so as to cover the first sealing film, and
wherein in causing the top section of the partition wall to be indented into the sealing film, the top section of the partition wall is indented into the first sealing film and the second sealing film.

14. The manufacturing method of an electrophoretic apparatus according to claim 13,
wherein in the second sealing film, a film thickness is thin and film hardness is hard as compared to those in the first sealing film.

15. The manufacturing method of an electrophoretic apparatus according to claim 13,
wherein an elastic modulus of the first sealing film is 5 MPa or more and 40 MPa or less, and
wherein an elastic modulus of the second sealing film is 50 MPa or more and 600 MPa or less.

16. The manufacturing method of an electrophoretic apparatus according to claim 13,
wherein a film thickness of the first sealing film is 2.5 μm or more and 7.5 μm or less, and
wherein a film thickness of the second sealing film is 0.05 μm or more and 0.5 μm or less.

17. The manufacturing method of an electrophoretic apparatus according to claim 13,
wherein an additive lowering the elastic modulus is added to a material of the second sealing film.

18. The manufacturing method of an electrophoretic apparatus according to claim 13,
wherein an amount of additive to be added to the first sealing film is 5 wt % or more and 50 wt % or less in a solid content of the first sealing film.

19. The manufacturing method of an electrophoretic apparatus according to claim 13,
wherein a volume resistivity of the first sealing film is 1×10⁷ Ω·cm or more and 5×10¹⁰ Ω·cm or less, and
wherein a volume resistivity of the second sealing film is 1×10⁷ Ω·cm or more and 2×10¹¹ Ω·cm or less.

20. An electronic apparatus comprising the electrophoretic apparatus according to claim 1.
